(19) United States
(12) Patent Application Publication
(10) Pub. No.: US 2021/0334263 A1
(43) Pub. Date: Oct. 28, 2021

(54) DETECTING AND ADDRESSING CLASHING TRANSACTIONS IN A SERVICE-BASED ARCHITECTURE

(71) Applicant: Telefonaktiebolaget LM Ericsson (publ), Stockholm (SE)

(72) Inventors: Dinand ROELAND, Sollentuna (SE); György MIKLÓS, Pilisborosjenö (HU); Zoltán TURÁNYI, Szentendre (HU); András ZAHEMSZKY, Sollentuna (SE)

(21) Appl. No.: 16/333,400

(22) PCT Filed: Jan. 7, 2019
(86) PCT No.: PCT/EP2019/050201

§ 371 Date: Mar. 14, 2019

Related U.S. Application Data
(60) Provisional application No. 62/697,127, filed on Jul. 12, 2018.

(51) Int. Cl. G06F 16/23; G06F 16/22; G06F 16/2457

(52) U.S. Cl. CPC G06F 16/2308; G06F 16/24575; G06F 16/2291

(57) ABSTRACT

A method of processing service requests in a service-based network architecture comprising a plurality of service instances includes receiving, at a service, a service request from a sender, the service request including a user identification, ID, associated with the request and a transaction ID associated with the request, obtaining a user context associated with the user ID from a user context database, the user context including a user context version and a transaction ongoing flag, determining based on the transaction ongoing flag whether a transaction involving the user ID is currently ongoing, in response to determining that a transaction involving the user ID is not currently ongoing, processing the service request to obtain an updated key value, and transmitting a store request to the user context database to store the updated key value, and an updated user context version in the user context database.

### RELATED APPLICATION

The present application claims the benefit of and priority to U.S. Provisional Patent Application No. 62/697,127, filed Jul. 12, 2018, entitled “DETECTING AND ADDRESSING CLASHING TRANSACTIONS IN A SERVICE-BASED ARCHITECTURE,” the disclosure of which is hereby incorporated herein by reference in its entirety.

### BACKGROUND

The present disclosure relates generally to communications systems, and more particularly, to communications systems that employ a service-based architecture and related nodes.

The 3GPP evolved packet core (EPC) architecture defines monolithic functional entities that provide various services within a network. For example, in the control plane, these entities include the mobility management entity (MME) for mobility handling and the Policy and Charging Rules Function (PCRF) for policy handling. The 3GPP standard specifies the logical interfaces between different functional entities. Some aspects of the entities, such as resilience and scalability of the entities, are not specified in the standard but are left to vendors as implementation aspects.

The 3GPP 5G core for the control plane follows a different paradigm where the large monolithic functional entities may be split up into smaller network functions. Network functions are connected to each other via a logical communication bus. A network function instance is registered to a network repository function (NRF) function. Using the NRF, a network function instance can find other network function instances to communicate with. FIG. 1 illustrates an example 5G system architecture; see 3GPP TS 23.501 for further details. As shown in FIG. 1, functional entities (e.g., AMF, SMF, etc.) are connected to a logical communication bus. The Access and Mobility Management Function (AMF) communicates with the radio access network (RAN) and one or more user equipments (UE), and the session management function (SMF) communicates with the user plane function (UPF). This way of modelling the system is also known as “service-based architecture.” The goal of a service-based architecture is to obtain a higher flexibility in the overall system, making it easier to introduce new services.

Each network function may have many instances, and each instance can provide the service of that network function. Mechanisms to select an instance of a network function (load balancing), to increase the number of instances (scale out) or to decrease the number of instance (scale in) are to a large extent not specified in the 3GPP standard but are left as implementation aspects.

In one possible implementation of a service-based architecture, the concept of a “stateless” design may be applied. Normally, a network function instance holds information about a user. For example, a session management function (SMF) instance may store a list of user plane sessions that are active for a given user equipment (UE). Or, a policy control function (PCF) instance may store policy rules that currently apply for a UE. This user information is also known as “user state” or “user context.” In a stateless design, the network function instance may store the user context in an external database, i.e., outside the instance. This simplifies the way that scaling and resiliency can be achieved, as subsequent requests for a user context do not necessarily need to be served by the same network function instance. If an instance receives a service request for a user context, it simply reads the latest user context from the database, performs some action(s), and writes the new user context to the database. Note that the different instances of a network function may all have access to the same external database.

In theory, different service requests for a user context may be directed to different network function instances that may run on different physical processing blades, which may limit performance. To achieve a good performance, several optimizations are possible. For example, the database used may be a real-time in-memory distributed database. In another example, service requests may include the identity of the user. A load balancer may use that user identity to ensure that subsequent requests for a user are directed to the same network function instance. In yet another example, the distributed database may ensure that user context information elements are stored at the same physical processing blade as the network function instance that produces or consumes them. This approach may reduce latency for data access, and information elements may be moved to another processing blade if another instance starts to access these elements, which may happen, for example, due to scaling, resiliency, or mobility.

The service-based architecture of the control plane may be modeled as a transaction processing system, as illustrated in FIG. 2A. FIG. 2A illustrates several network functions, or “services”, A through O, arranged in a hierarchy. Some of the services (e.g., H through O) may communicate with user plane (UP) entities. Each service may have multiple instances, and each instance may have access to a database to read and write user context information.

A transaction initiator starts a transaction T1 by sending a service request to a first service (e.g., service A). When processing the service request, the first service A may in turn generate service requests to one or more other services. In the example illustrated in FIG. 2A, service A may send a request to service B, and service B may send a request to service D, service D may send a request to service H, and service H to UPa. Eventually, replies will be sent to the requesters in the opposite direction, eventually ending with a reply from service A back to the transaction initiator. A transaction may be defined as a complete series of messages through the system starting with the request sent by the transaction initiator and ending when the transaction initiator receives the reply to its request.

Transactions may start at any level in the hierarchy. For example, a transaction T2 may be initiated via a request to service G as illustrated in FIG. 2A. Transactions may fork; for example, service A may send requests to both service B and service C. When forking, the service performing the forking cannot reply to its requester until it has received all replies.

This model of a transaction processing system can be applied to any implementation of a 3GPP service-based architecture. For example, when the AMF receives a “PDU session establishment” message for a UE from the RAN, then the AMF contacts the SMF to establish the user plane session, and the SMF in turn contacts the Unified Data Management (UDM) function to query the user profile and the PCF to retrieve the correct policy rules for the session.

Although the services illustrated in FIG. 2A are arranged in a control plane hierarchy in which requests always flow in one direction, in a more general model, the services may be arranged in a non-hierarchical manner, as illustrated in FIG. 2B. As shown therein, services A through F may be provided, and transactions can be initiated anywhere in the network.

### SUMMARY

A method of processing service requests in a service-based network architecture comprising a plurality of service instances includes receiving, at a service, a service request from a sender, the service request including a user identification, ID, associated with the request and a transaction ID associated with the request, obtaining a user context associated with the user ID from a user context database, the user context including a user context version and a transaction ongoing flag, determining based on the transaction ongoing flag whether a transaction involving the user ID is currently ongoing, in response to determining that a transaction involving the user ID is not currently ongoing, processing the service request to obtain an updated key value, and transmitting a store request to the user context database to store the updated key value, and an updated user context version in the user context database.

A network node of a communication network includes a network interface configured to provide network communication with other network nodes, and a processor coupled with the transceiver, wherein the processor is configured to provide wireless network communications through the transceiver, and wherein the processor is configured to perform operations of receiving, at a service, a service request from a sender, the service request including a user identification, ID, associated with the request and a transaction ID associated with the request, obtaining a user context associated with the user ID from a user context database, the user context including a user context version and a transaction ongoing flag, determining based on the transaction ongoing flag whether a transaction involving the user ID is currently ongoing, in response to determining that a transaction involving the user ID is not currently ongoing, processing the service request to obtain an updated key value, and transmitting a store request to the user context database to store the updated key value, and an updated user context version in the user context database.

Some embodiments described herein provide a service based transaction method architecture that detects and handles clashing transactions. The embodiments described herein may provide the advantage of being able to handle clashing transactions without using locks, time-outs, or re-tries.

### BRIEF DESCRIPTION OF THE DRAWINGS

The accompanying drawings, which are included to provide a further understanding of the disclosure and are incorporated in a constitute a part of this application, illustrate certain non-limiting embodiments of inventive concepts. In the drawings:

FIG. 1 is a block diagram illustrating a service based architecture for a wireless communication network.

FIGS. 2A and 2B are block diagrams illustrating arrangements of service functions in a service-based architecture.

FIGS. 3A, 3B and 3C are flow charts illustrating operations of service systems/methods according to some embodiments of inventive concepts.

FIGS. 4 and 5 are flow diagrams illustrating message flows and operations in a service-based architecture according to some embodiments of inventive concepts.

FIG. 6 is a flow chart illustrating operations of service systems/methods according to some embodiments of inventive concepts.

FIG. 7 is a flow diagram illustrating message flows and operations in a service-based architecture according to some embodiments of inventive concepts.

FIG. 8 illustrates a user context data structure according to some embodiments of inventive concepts.

FIG. 9 is block diagram illustrating features of a network node that implements a service function in a service-based architecture according to some embodiments of inventive concepts.

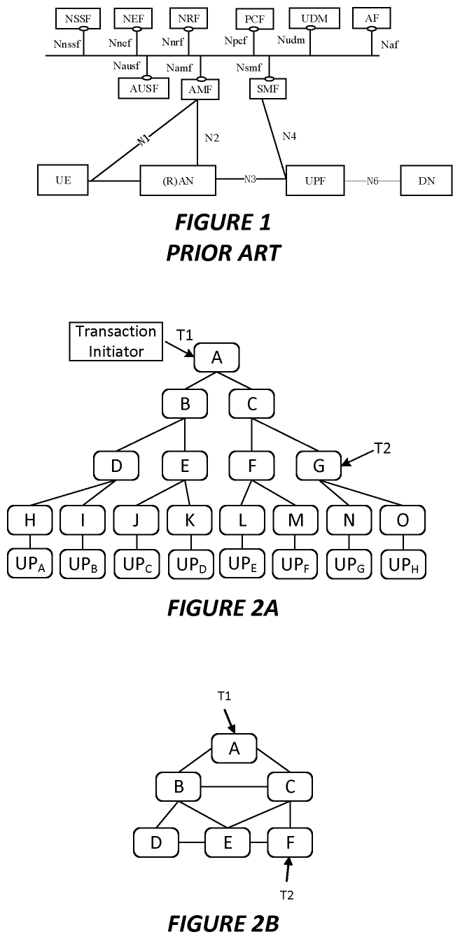

Figure QQ1 is a block diagram of a wireless network in accordance with some embodiments.

Figure QQ2 is a block diagram of a user equipment in accordance with some embodiments

Figure QQ3 is a block diagram of a virtualization environment in accordance with some embodiments.

Figure QQ4 is a block diagram of a telecommunication network connected via an intermediate network to a host computer in accordance with some embodiments.

Figure QQ5 is a block diagram of a host computer communicating via a base station with a user equipment over a partially wireless connection in accordance with some embodiments.

Figure QQ6 is a block diagram of methods implemented in a communication system including a host computer, a base station and a user equipment in accordance with some embodiments.

Figure QQ7 is a block diagram of methods implemented in a communication system including a host computer, a base station and a user equipment in accordance with some embodiments.

Figure QQ8 is a block diagram of methods implemented in a communication system including a host computer, a base station and a user equipment in accordance with some embodiments.

Figure QQ9 is a block diagram of methods implemented in a communication system including a host computer, a base station and a user equipment in accordance with some embodiments.

### DESCRIPTION OF EMBODIMENTS

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

In a service-based control plane model such as those illustrated in FIGS. 2A and 2B, it may happen that multiple transactions for a user are ongoing concurrently. For example, a user represented by a UE may request a network service, such as attach or adding a PDU session, while at the same time the profile of the user may be modified by a management system, leading to an update in the policy rules associated with the UE.

When transactions occur concurrently, it is possible that a service may receive multiple requests relating to the same user at the same time. These requests may end up at the same service instance, but could even end up at different service instances. Without taking further precautions, this may lead to a corrupted user context in the user context database. This in turn may lead to incorrect handling of the user's traffic.

Several difficulties may arise. For example, the fact that there are two messages for the same user needs to be detected by the system. This is not easy, as two messages for the same user may end up at different service instances. In most cases this will not happen, since the load balancing mechanism will prefer to use a single instance for a user, but it could happen, such as when instances are scaled in or out.

Moreover, once it has been detected that there are two messages relating to the same user, a proper decision needs to be taken how to handle the situation, which is not trivial. For example, assume the instance handling the first message can place a lock on the user context. A lock supervision mechanism would be needed in case the instance crashes before the lock is released. If a lock is used, the second message could be buffered until the lock is released. However, the lock may not get released because processing the first message includes waiting for another process. It is difficult to distinguish an error situation (such as a dead-lock) from a non-error situation where the process that placed the lock simply takes a long time. A sophisticated mechanism may be designed to decide what the right action should be. However, that may entail significant added complexity. Both detecting the situation and dealing with the situation could complicate the overall system. When dealing with parallel processing in a service-based architecture, the existing solutions can become very complex. Scaling and resilience handling add even further to this complexity.

Some embodiments described herein provide a service based transaction architecture that detects and handles clashing transactions wherein the service instances do not use locks, time-outs, or no re-tries. The systems/methods described herein assume that clashing transactions are rare, and therefore the systems/methods can be designed for an opportunistic approach.

The systems/methods described herein provide a generic framework for handling clashing transactions that uses a versioning user context database. Clashes are detected by saving the identity of the ongoing transaction in the database together with the user context data and an associated version. When a clash is detected, the execution of the ongoing procedure is terminated, with an error message being sent back to the transaction initiator. Using the versioning user context database, it is possible to revert the user context state to a previous version before the start of the transaction. The transaction initiator may then re-try the procedure after a back-off time interval. Using a randomized back-off time, it may be possible to help avoid consecutive clashes.

For the embodiments described herein, the following assumptions are made:

(a) The user context database is provided as a key-value store with support for versioning. When a key value is read, it is possible to read the version of the value at the same time. When a key value is written, it is possible to specify the version of the new value. Attempting to write to a version other than the one following the latest version available in the user context database results in an error.

(b) Signaling for a transaction takes the form of either a request to a service or a reply from a service. Signaling for a transaction is performed in a sequential fashion only, i.e., there are no “loops” permitted between the services. For example, if a transaction initiator initiates a transaction by sending a request to service A, and service A sends a request to service B, then service B may not send a request to service A. This restriction is enforced by keeping track of a current transaction as described in more detail below. Forking is allowed, however. For example, service B may send requests to both service C and service D. However, service C and service D may not send requests to the same service E, as that would create a loop.

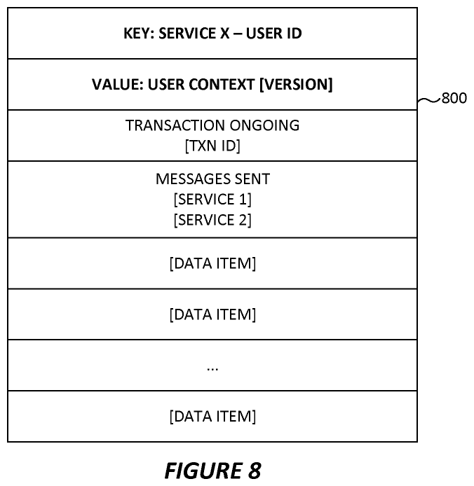

(c) A user context in the user context database is stored on the granularity of service combined with user. For example, user context in service A for user X may be “Service A, user X”, which tuple provides the key for the database entry, while the user context provides the value associated with the key. Brief reference is made to FIG. 8. As shown therein, a user context 800 includes a “Transaction Ongoing” (TO) field or flag which may include a transaction ID, and a “Messages Sent” table that indicates to which other services this service has sent requests as part of this transaction. In addition, the user context may contains other data items required for the operation of the service (for example, a data item “counter”). Previous versions of the user context may be kept in the user context database for later reference, such as if it is necessary to roll back the user context to a previous version.

According to some embodiments, the following procedure may be performed by a service instance when receiving a request message. The request message contains a sender service ID that identifies the service that sent the request (i.e., the transaction initiator from the standpoint of the service that receives the request), a globally unique user ID, a globally unique transaction ID, and optionally other transaction parameters.

A1) First, the service that receives a request reads the user context associated with the user ID contained in the request from a user context database, along with the version of the user context. The user context is stored in local memory for this instance. The locally stored version of the user context is referred to herein as the “local user context.”

A2) Next, the service checks the user context to determine if a “Transaction Ongoing” (TO) flag is set. If so, the service returns an error message to the sender, e.g., “error—transaction clash,” indicating that a transaction clash has occurred. The procedure then ends.

A3) If the TO flag is not set, the service performs the requested processing based on the local user context and the other transaction parameters. This may result in changes to the local user context.

A4) The service determines whether one or more messages need to be sent to other services to fulfill the request. Such messages are referred to herein as “secondary requests.” If a secondary request is needed, then the service performs the following:
a) Set the “Transaction Ongoing” flag to the transaction ID in the local UE context.
b) Store the identity of the service to which the secondary message is sent in the “Messages Sent” table of the local user context.
c) Store the local user context in the user context database, in the version received by the service at the last read operation increased by one. If this operation fails, then another service has written to the user context database after the last read by the current service. The service has now detected a clashing transaction, and thus sends a reply message containing “error—transaction clash” to the sender service ID, and terminates the procedure.
d) Otherwise, if the store operation is successful, the service sends the secondary request message(s) that need to be sent, and ends the procedure.

A5) If no secondary request messages need to be sent to other services, then the service performs the following:
a) Clear the “Transaction Ongoing” flag in the local user context.
b) Store the local user context in the user context database, in the version received by the service at the last read operation increased by one. As part of the user context, also store the reply message. If this operation fails, then another service has written to the user context database after the last read by the current service. The service has now detected a clashing transaction, and thus sends a reply message containing “error—transaction clash” to the sender service ID, and terminates the procedure.
c) Otherwise, if the store operation is successful, then the service sends a positive reply message (“Ok”) to the sender service ID, and the procedure ends.

The following procedure is performed by a service instance when receiving a reply message to a secondary service request. The reply message contains a sender service ID, globally unique user ID, a globally unique transaction ID, a reply code (e.g., “Ok” or “error”), and optionally other transaction parameters.

B1) The service reads the user context for the identified user ID, including the version of that user context, from the user context database and stores the user context into the local user context.

B2) The service checks the user context to determine if transaction ID corresponds to the ongoing transaction. If not, the service may simply drop the reply message and end the procedure.

B3) The service checks to see if the reply message indicates an error “transaction clash”. If so, then the service rolls back the user context to the version before the transaction started (that is, the previous version), and returns a reply “error—transaction clash” to the sender service ID. The procedure then ends.

B4) If the service determines that the reply is associated with the ongoing transaction, the service checks the “Messages Sent” table to determine if the reply was expected. If it was not, the service may simply drop the message and end the procedure. In some embodiments, the service may send a negative response back to the service that sent the reply, or take another action.

B5) The service may then mark the reply as “received” in the “Messages Sent” table of the local user context. If the “Messages Sent” table indicates that the service is waiting for additional replies, then the service may end the procedure and continue to wait for the additional replies.

B6) If no additional replies are expected, the operations return to step (A3) in the procedure above for the service to perform the requested processing based on the user context and the reply to the secondary service request.

A procedure according to some embodiments may be non-blocking and may not deal with time-outs or retries. Therefore, implementation of message handling in the services can be kept simple. Note that, even though the services do not need to implement time-out and retries, the transaction initiator may implement such procedures as described in more detail below.

In some embodiments, the transaction initiator will re-try a request when it receives an “error—transaction clash” message. The transaction initiator may use a policy such as exponential back-off for re-trying (e.g., a back-off period may be selected based on an exponentially distributed random variable). The transaction initiator may continue to re-try until it receives a reply without a clash error, or it may give up after a certain number of re-tries depending on the application. The service may also add additional information in the reply error message, such as information about the transaction that caused the clash. If the other transaction has a high/higher priority than the current transaction, then the transaction initiator may use a longer delay before re-trying the current transaction.

The transaction initiator may also have the responsibility to time-out a request. This may happen if one of the services of the transaction crashes while it is processing the request. In that case, no reply message will be sent back to the transaction initiator. There are several ways to deal with this issue. One way is to add an additional step between step A1 and step A2 in the “receiving a request message” procedure described above. The resulting procedure to be followed when a request message is received is shown below. The request message contains the same information as before, but with an additional “re-try” flag set in the request message. The “re-try” flag may take the form of a counter, so that multiple retransmissions can be distinguished from each other.

C1) Read the user context for the user ID included in the request message, including the version of that context. The user context is placed in the local user context.

C2) If the “re-try” flag is set in the request, then the following situations are possible:
a) The transaction indicated in the request is still ongoing. In this case the “Transaction Ongoing” flag in the user context is the same ID value as the one in the request. In this case, we rollback the user context to the version before this transaction started (that is, the previous version), and proceed with step C4.
b) Or, the transaction indicated in the request has been ongoing in this service but was already finished and the reply message was lost. In this case, the reply for this transaction needs to be re-sent. This reply can be found in the versioned user context database of the user context (given that it also got saved just before sending the reply). After re-sending the reply, the procedure ends.
c) Or, the transaction indicated in the request has never been ongoing in this service. This may happen if a request is lost. In this case, the reply message cannot be found in the versioned user context database (the search for the reply message may be limited to a time-window or to a maximum number of earlier versions, so that the service does not need to check all previous versions). In this case, the operations proceed with step C3.

C3) The service checks to see if “Transaction Ongoing” flag is set in the user context. If so, the system returns a reply “error—transaction clash” to the sender service ID and ends the procedure.

C4) The service processes the request based on the local user context and the other transaction parameters, which may result in changes to the local user context.

C5) If one or more messages need to be sent to other services, then the service performs the following:
a) Set the “Transaction Ongoing” field to transaction ID in the local UE context.
b) Along with this, store the identity of the service to which the secondary request message is sent in the “Messages Sent” table.
c) Store the local user context in the user context database, in the version received by the service at the last read operation increased by one. If the store operation fails, then another service has written in the user context database after the last read by the current service. The service has therefore detected a clashing transaction, and so returns a reply “error—transaction clash” to the sender service ID, and ends the procedure.
d) Otherwise, if the store operation succeeds, the service sends any secondary request messages that need to be sent. If the “re-try” flag was set in the request, then it is also set here. The procedure then ends.

C6) If no messages need to be sent to other services, then the service performs the following:
a) Clear the “Transaction Ongoing” field.
b) Store the local user context in the user context database, in the version received at the last read increased by one. As part of the user context, the reply message is also stored. If the store operation fails, then another service has written in the user context database after the last read by the current service. The service has therefore detected a clashing transaction, and so returns a reply “error—transaction clash” to the sender service ID, and ends the procedure.
c) Otherwise, if the store operation succeeded, then the service sends a reply “ok” to the sender service ID and ends the procedure.

In some embodiments, the rollback mentioned in step C2 may be skipped. In that case, the processing in step C4 simply re-runs on the latest context. A similar approach for some embodiments is skipping the search in the user context database in step C2. Instead, the request is simply re-run on the latest user context in step C4. This is possible when the “Transaction Ongoing” flag is not set (by another transaction).

As yet another modification for some embodiments, it is possible to skip the rollback in step C2 when the transaction indicated in the request is still ongoing. That is because in this situation it can be assumed that the service is waiting for a reply from another service which does not arrive due to a lost message. Instead of the rollback, the service may re-send the previously sent messages to other services for which no response has arrived. For this to work, the messages sent to other services may also be saved in step C5.

Another way to implement the re-try is a two-phase approach. First, the request is processed by all services involved just as described before. However, when sending back the reply, the “Transaction Ongoing” flag is not cleared. When the transaction initiator receives the reply, all “Transaction Ongoing” flags are still set. To finish the procedure, the transaction initiated sends a second request, whose only purpose is to clear the “Transaction Ongoing” flag. The path followed is the same as in the first request, and the clearing of the flag is performed on the reply.

The transaction initiator may be another service, but would typically be at the edge of the service-based domain. In the current 3GPP specification, the service-based domain is restricted to the core network control plane. The transaction initiator could, for example, be the AMF, or it could be a function between the non-service-based domain and the service-based domain that also performs tasks like signaling protocol conversion (between the domains), load balancing, etc.

### Clash Case Example #1

Assume a configuration as shown in FIG. 2A where transactions T1 and T2 simultaneously initiate a transaction. Transaction T1 follows a path of A->C->G->N->UP, and T2 follows a path of G->N->UP. A clash may happen at service G. According to some embodiments, this will result in the following events:

If transaction T1 reaches service G before T2 then the flag or the versioning will cause transaction T2 to back-off (that is, service G will return an error back to transaction T2's transaction initiator).

If transaction T2 reaches service G before transaction T1, then the flag or the versioning will make transaction T1 back-off (that is service G will return an error back to service C, which will return an error back to service A, which will return an error back to transaction T1's transaction initiator).

Before doing the back-off, there is transaction T1 state in service C and service A. When doing the back-off, the service rolls back the state (e.g., step C3 above). When the transaction initiator receives the reply (i.e., the error), the state in both service C and service A is back to the version before transaction T1 started. The transaction initiator re-tries as described above.

In some embodiments, the rollback step can be skipped if it can be assumed that transactions always go in one direction (e.g., south-bound) only, and the transaction initiator retries until it receives a reply other than “error—transaction clash”.

### Clash Case Example #2

Assume the previous example, with the difference that transaction T2 travels north-bound instead. So, T2 follows a path of G->C->A. A clash may happen in service C. According to some embodiments, this will result in the following events:

If transaction T1 reached service C first, then transaction T2 fails (based on flag or versioning) and will back-off. Transaction T1 may continue successfully, or it may clash in service G. This depends on the speed of the back-off of transaction T2. Either way, transaction T2 and possibly transaction T1 will back-off with rollback. Both transaction initiators will re-try.

The procedure is the same if transaction T2 reached service C first.

The re-try by the transaction initiator may happen with a certain random delay, such as by a random exponential back-off.

### Clash Case Example #3

Assume a configuration as shown in FIG. 2B. Loops within a single transaction should not occur, and can easily be detected by reading the TO flag. For example, assume that T1 follows the path A->B->E->D and T2 follows the path F->E->C. The transactions may clash in service E. The result of handling the clash is similar as in the previous example.

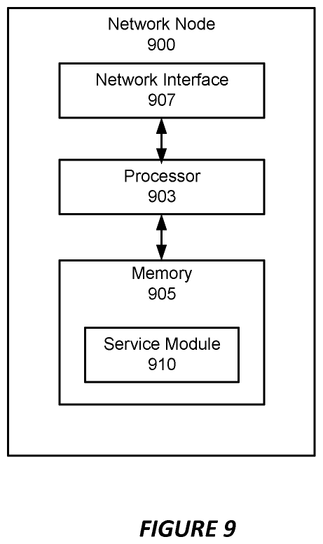

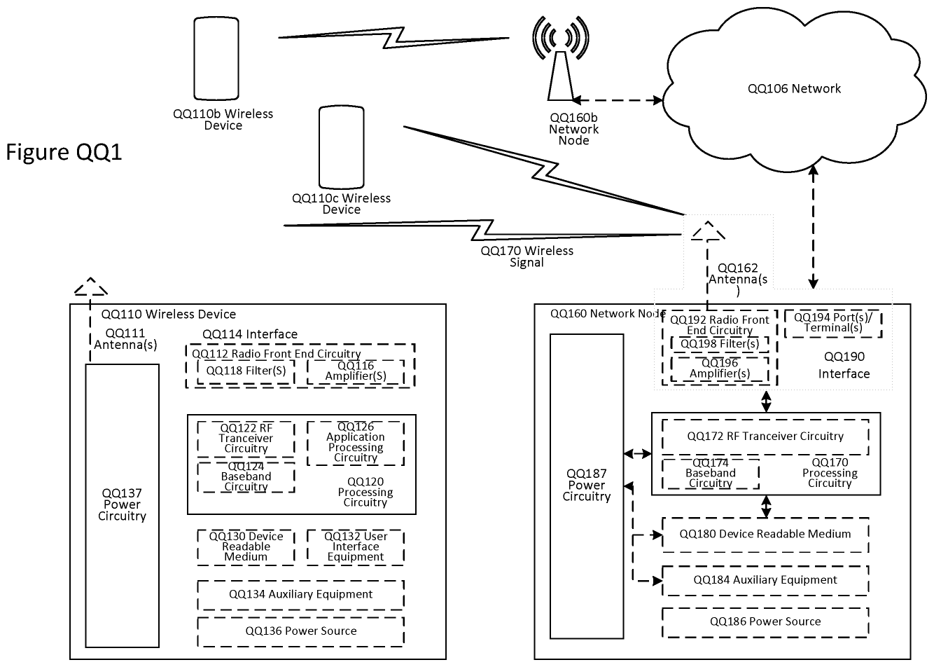

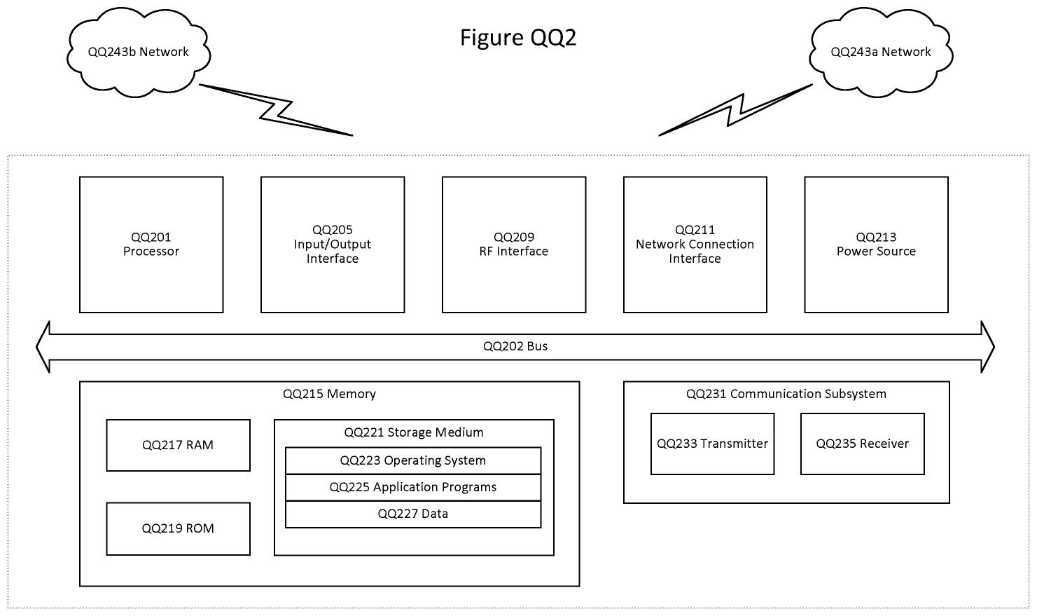

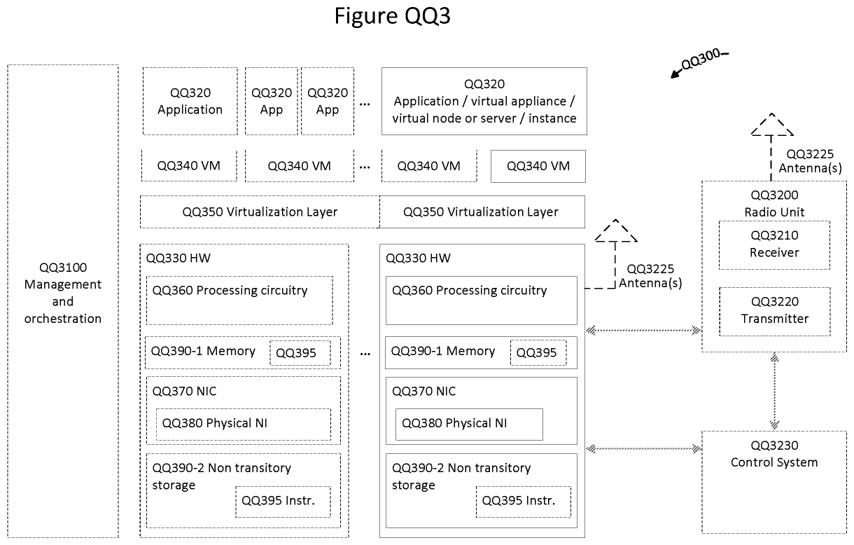

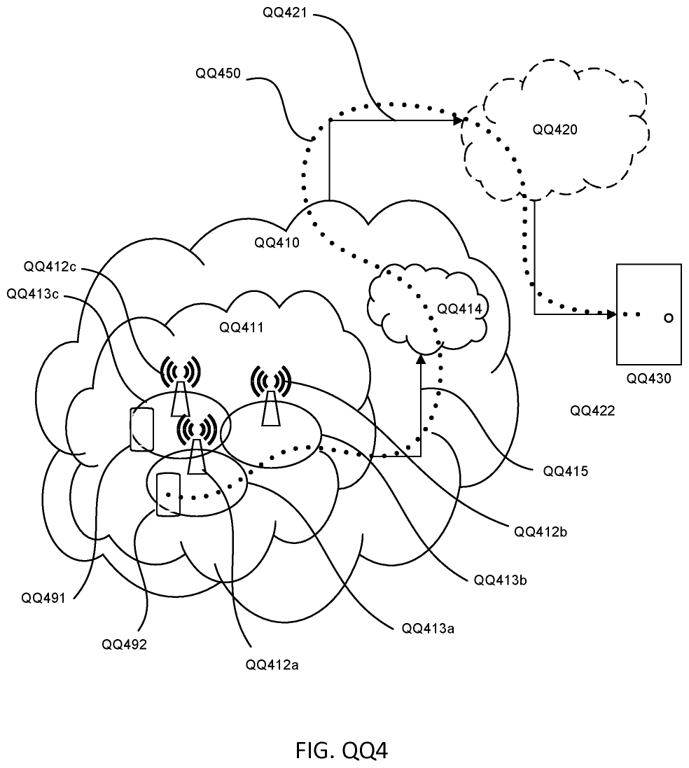

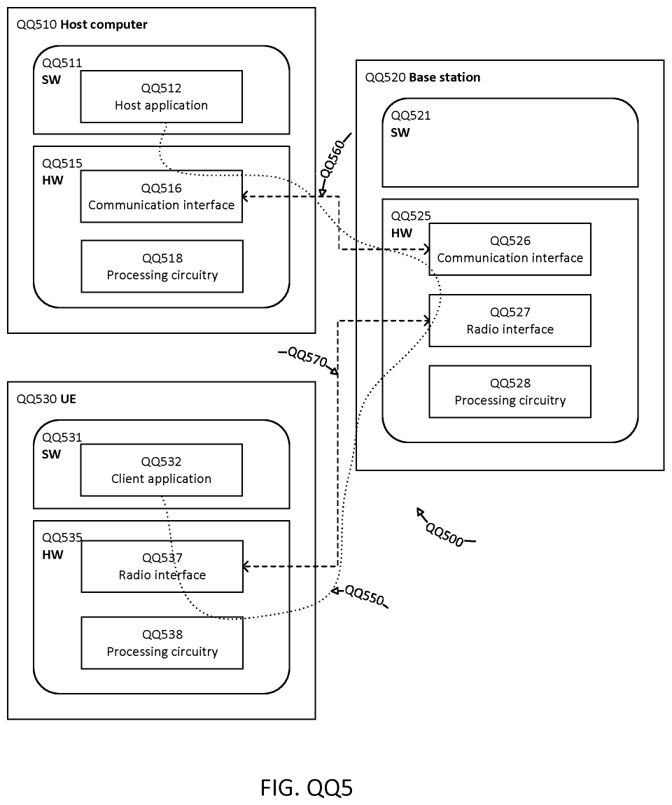

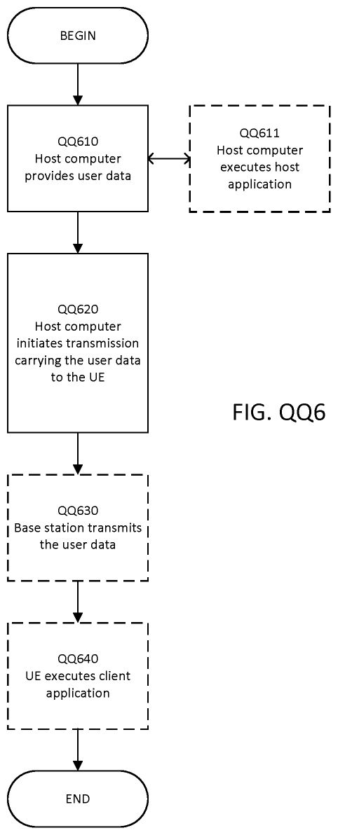

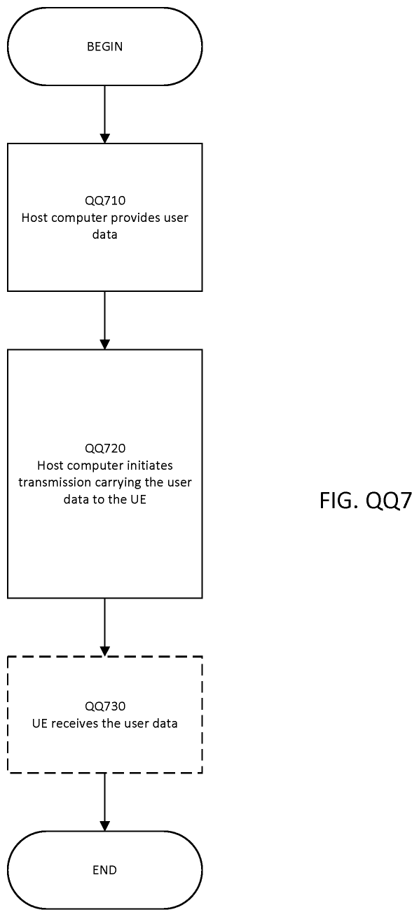

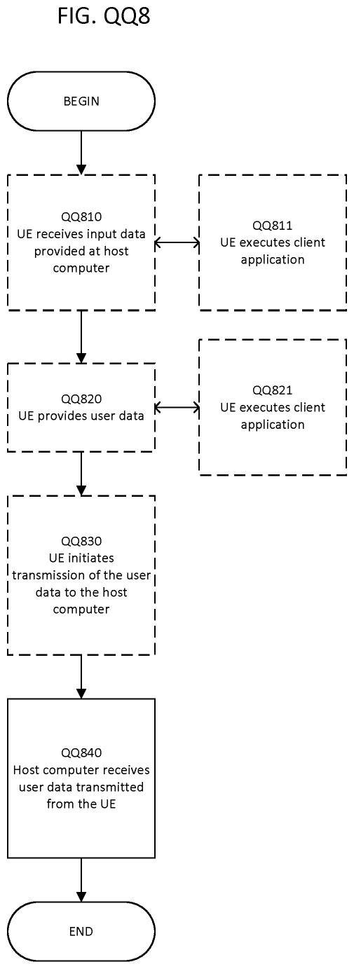

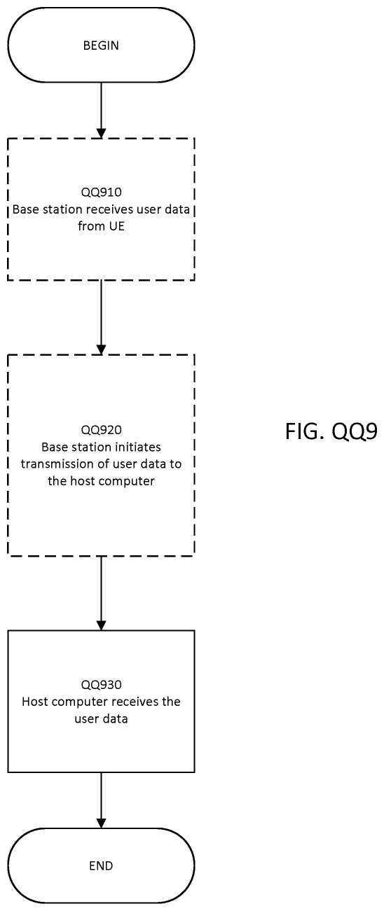

FIG. 9 is a block diagram illustrating elements of a network node of a communication system having a service-based architecture according to embodiments of inventive concepts. As shown, the network node may include a network interface circuit 907 (also referred to as a network interface) configured to provide communications with other nodes (e.g., with other base stations and/or core network nodes) of the communication network. The network node may also include a processor circuit 903 (also referred to as a processor) coupled to the transceiver circuit, and a memory circuit 905 (also referred to as memory) coupled to the processor circuit. The memory circuit 905 may include computer readable program code that when executed by the processor circuit 903 causes the processor circuit to perform operations according to embodiments disclosed herein. According to other embodiments, processor circuit 903 may be defined to include memory so that a separate memory circuit is not required.

As discussed herein, operations of the network node may be performed by processor 903 and/or the network interface 907. For example, the processor 903 may control the network interface 907 to transmit communications through network interface 907 to one or more other network nodes and/or to receive communications through network interface from one or more other network nodes. Moreover, modules may be stored in memory 905, and these modules may provide instructions so that when instructions of a module are executed by processor 903, processor 903 performs respective operations (e.g., operations discussed herein with respect to Example Embodiments). For example, the memory 905 may include a service module 910 that configures the network node to perform operations of a service as described herein.

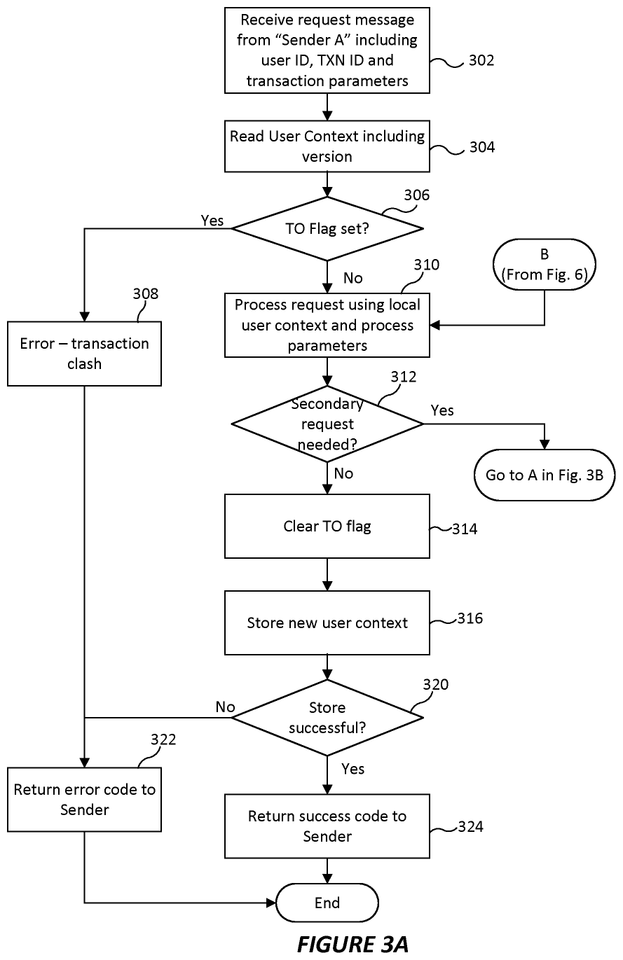

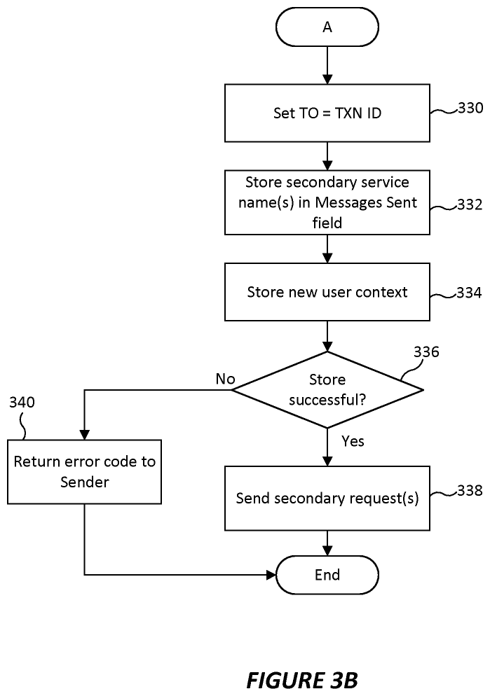

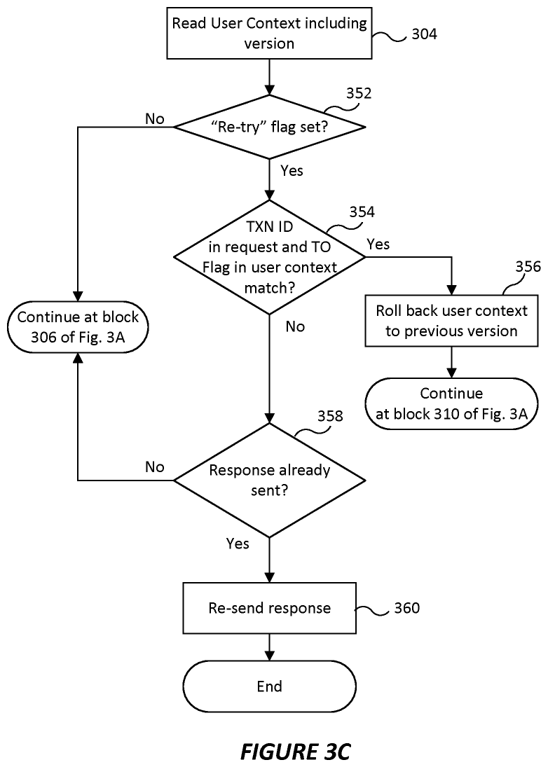

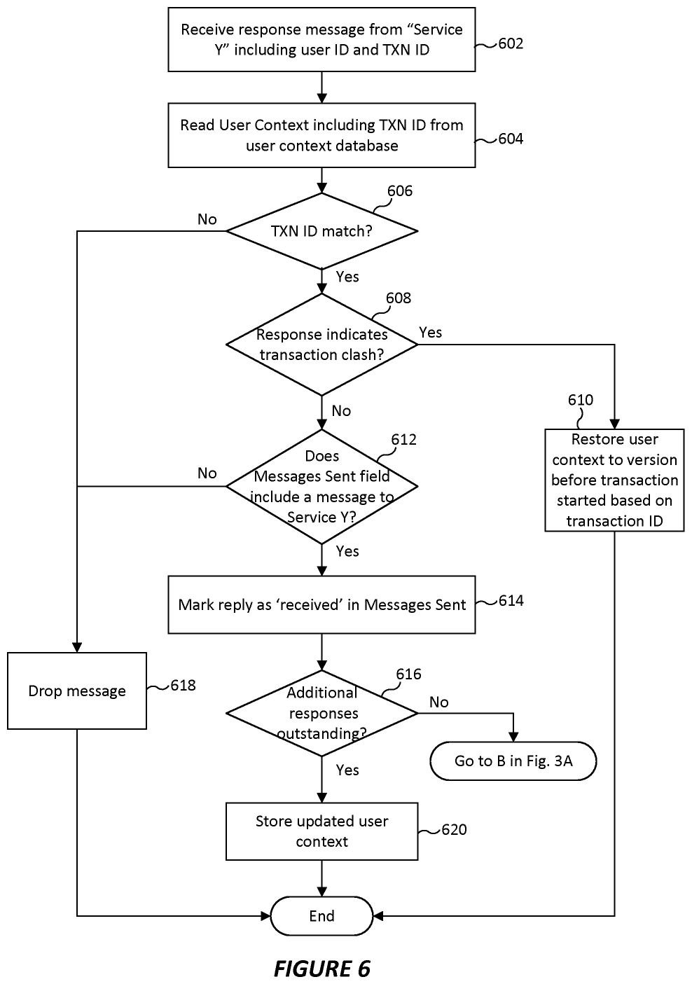

Operations of a service implemented in a network node 900 will now be discussed with reference to the flow charts of FIGS. 3A, 3B, 3C and 6. For example, modules may be stored in the memory 905 of the network node, and these modules may provide instructions so that when the instructions of a module are executed by processor 903, processor 903 performs respective operations of the flow charts of FIGS. 3A, 3B, 3C and 6.

Referring to FIG. 3A, operations associated with receiving and processing a request message according to some embodiments are illustrated. Referring to FIG. 3A, a service (e.g., Service X) receives a request message from a sender (“Sender A”), which may be a transaction initiator (block 302). The request message includes a sender service ID that identifies the service that sent the request, a globally unique user ID, a globally unique transaction ID (TXN ID), and optionally other transaction parameters. In response to receiving the request, the service obtains the user context for the user ID from a user context database (block 304). The user context may be represented as a tuple {K, Val, Ver N}, where K is the key identified by the service and user ID, Val is the value of the user context including its constituent data fields, and Ver N is the version (e.g., Version N) of the user context retrieved from the database. The service stores the user context locally in a local user context.

The user context, which is versioned, includes a “Transaction Ongoing” flag (TO flag). The service inspects the TO flag to determine if a transaction is currently ongoing (block 306). When a transaction is ongoing with respect to the user ID, the TO flag may be set to a value corresponding to a valid transaction ID; conversely when a transaction is not currently ongoing with respect to the user ID, the TO flag may be set to a value corresponding to an invalid transaction ID, such as ‘0000’. If the TO flag contains a valid TXN ID, then operations proceed to block 308 where the service concludes that a transaction clash has occurred, and then to block 322 where the service returns an error code to the sender service ID identified in the request.

If the TO flag is not set, operations proceed to block 310, where the service processes the request using the local user context and any available process parameters (block 310). This may result in an update to the local user context. The service then determines if any secondary requests are needed in order to fulfill the request (block 312). If one or more secondary requests are needed, operations proceed to location ‘A’ on FIG. 3B as described below. Alternatively, if no secondary requests are needed to fulfill the original request, operations proceed to block 314, where the service clears the TO flag in the local user context (e.g., by setting it to an invalid transaction ID value, such as ‘0000’). The service then attempts to store the modified local user context as a new version of the user context in the user context database (block 316). In particular, the service sends a request to the user context database to store the updated user context as a new version, e.g., {K, Val′, Ver N+1}, where K is the key name of the user context given by the user ID and the service name, Val′ is the updated user context and Ver N+1 is the next sequential version of the user context relative to the version stored in the local user context.

If the attempt to store the modified user context was unsuccessful, the service returns an error code to the sender service ID (block 322), which can re-try the transaction later as described above. If the attempt to store the modified user context was successful, the service returns a success code (e.g. “OK”) to the sender service ID (block 324), and operations conclude.

Referring to FIG. 3B, further operations of a service are illustrated. If it is determined at block 312 of the operations of FIG. 3A that one or more secondary requests are needed to fulfill the original request, then operations proceed to block 330 of FIG. 3B. At that point, the service sets the TO flag in the local user context equal to the transaction ID (TXN ID) of the current transaction (block 330). The service also stores the service name(s) of the service(s) to which secondary request messages will be sent in a “Messages Sent” table in the local user context (block 332). The service then attempts to store the modified local user context as a new version of the user context in the user context database (block 336). If the attempt to store the modified user context was unsuccessful, the service returns an error code to the sender service ID (block 340), which can re-try the transaction later as described above. If the attempt to store the modified user context was successful, the service sends the secondary request(s) to the identified service(s), and operations conclude.

FIG. 3C illustrates operations that may be performed in embodiments in which a “re-try” flag is used. These operations occur after the user context is read at block 304 of FIG. 3A. In these embodiments, after the user context is obtained, the service checks to see if a “re-try” flag is set in the request (block 352). If not, operations continue at block 306 of FIG. 3A. However, if a “re-try” flag is set in the request, the service checks at block 354 to determine if the value of the “Transaction Ongoing” flag in the user context is the same as the transaction ID identified in the request. If so, then the service rolls the user context back to the previous version before the transaction at block 356 and operations continue at block 310 of FIG. 3A. If the transaction ID in the request and the TO flag in the user context do not match, the service checks to see if a response has already been sent in the transaction identified in the request (block 358). If so, the system re-sends the response at block 360 and the operations end. If not, then it is assumed that the previous request was lost, and the operations continue at block 306 of FIG. 3A.

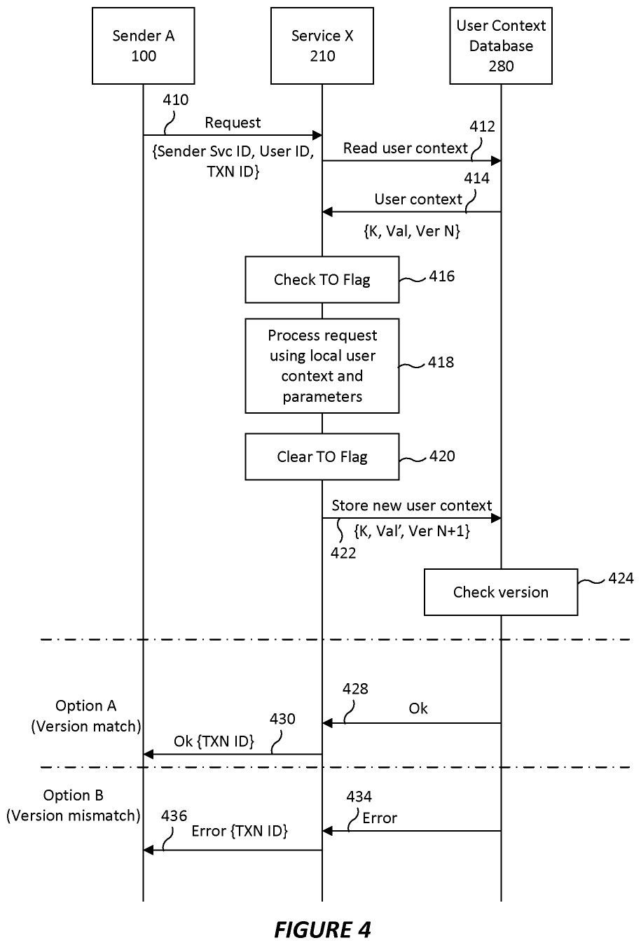

FIG. 4 is a flow diagram that illustrates an example of message flows between a sender 100 (“Sender A”), a service 210 (“Service X”), and a user context database 280 when the sender 100 sends a request message to the service 210 and no secondary requests are needed to fulfill the request. Referring to FIG. 4, a sender 100 may initiate a transaction by sending a request message 410 to the service 210. The request message 410 includes a sender service ID that identifies the service that sent the request, a user ID, a transaction ID (TXN ID), and optionally other transaction parameters. Upon receiving the request, the service 210 sends a message 412 to the user context database 280 to read the user context for the user ID identified in the request message 410. The user context databased 280 returns the user context in a message 414 to the service 210 in the form of a tuple {K, Val, Ver N}, where K is the key identified by the service and the user ID, Val is the value of the user context including its constituent data fields, and Ver N is the version (e.g., Version N) of the user context retrieved from the database. The service 210 stores the user context locally in a local user context.

The service 210 inspects the TO flag at block 416 to determine if a transaction is currently ongoing. Assuming in this example that the TO flag is not currently set (or is set to an invalid transaction ID) indicating that no other transaction is currently ongoing, the service 210 processes the request using the local user context and any available process parameters (block 418). This may result in an update to the local user context. Assuming in this example that no secondary requests are needed to fulfill the original request, the service 210 clears the TO flag in the local user context (e.g., by setting it to an invalid transaction ID value, such as ‘0000’) (block 420). The service then attempts to store the modified local user context as a new version of the user context in the user context database 280 by sending a store request message 422 to the user context database 280. In particular, the service 210 sends a request message 422 to the user context database 280 to store the updated user context as a new version, e.g., {K, Val′, Ver N+1}, where Val′ is the updated user context and Ver N+1 is the next sequential version of the user context relative to the version stored by the service 210 in the local user context.

The user context database 280 receives the request message 422 and checks the version of the user context that is being stored against the version currently stored in the database. If the version that the request message 422 specifies is acceptable, e.g., the version in the request is one version greater than the most recently stored version, then the user context database 280 returns a message 428 to the service 210 indicating that the new user context was successfully stored (“Ok”). The service 210 then sends a response 430 to the original request to the sender 100 indicating that the request was successfully completed. The response 430 may include the original transaction ID.

If the user context database 280 determines that the version is not acceptable (because, for example, another instance of the service had already updated the user context), the user context database 280 returns an error message 434 to the service 210 indicating that the store request was unsuccessful. The service 210 then returns an error message 436 to the sender service ID, which can re-try the transaction later as described above. The error message 436 may include the original transaction ID.

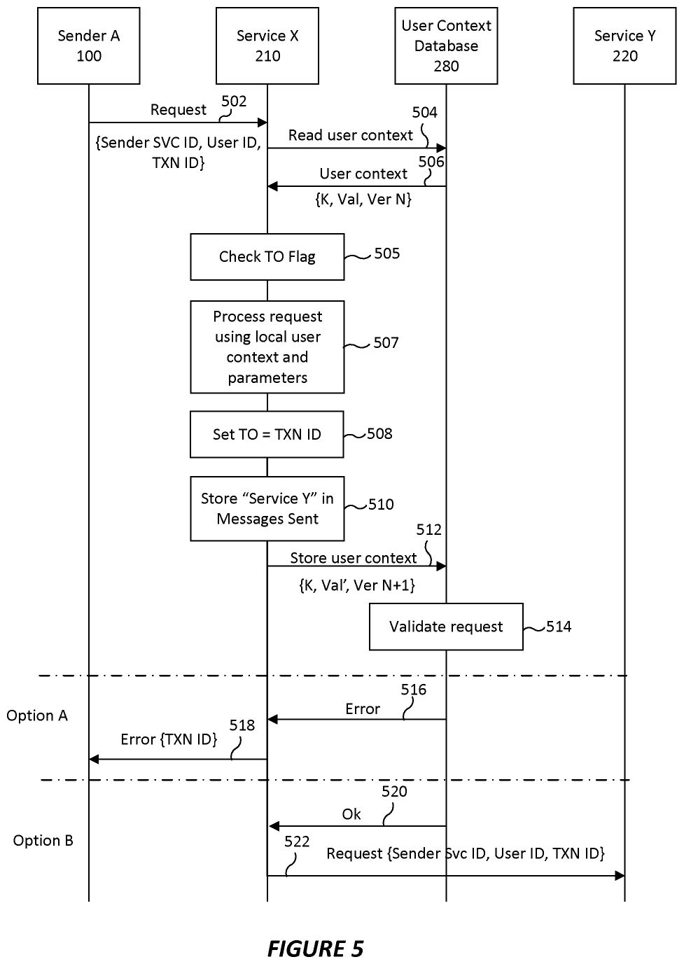

FIG. 5 is a flow diagram that illustrates an example of message flows between a sender 100, a service 210, a secondary service 220, and a user context database 280 when the sender 100 sends a request message to the service 210 and one or more secondary requests are needed to fulfill the request. Referring to FIG. 5, a sender 100 may initiate a transaction by sending a request message 502 to the service 210. The request message 502 includes a sender service ID that identifies the service that sent the request, a user ID, a transaction ID (TXN ID), and optionally other transaction parameters. Upon receiving the request, the service 210 sends a message 504 to the user context database 280 to read the user context for the user ID identified in the request message 502. The user context databased 280 returns the user context in a message 506 to the service 210 in the form of a tuple {K, Val, Ver N} as described above. The service 210 stores the user context locally in a local user context.

The service 210 inspects the TO flag at block 505 to determine if a transaction is currently ongoing. Assuming in this example that the TO flag is not currently set (indicating that no other transaction is currently ongoing), the service 210 processes the request using the local user context and any available process parameters (block 507). This may result in an update to the local user context. Assuming in this example that based on the processing in block 507, the service 210 determines that one or more secondary requests are needed to fulfill the original request, the service 210 sets the TO flag in the local user context equal to the transaction ID TXN ID (block 508), and stores the service ID(s) of the service(s) to which the service 210 will send the secondary request(s) in a “Messages Sent” table in the local user context (block 510). The service then attempts to store the modified local user context as a new version of the user context in the user context database 280 by sending a store request message 512 to the user context database 280. In particular, the service 210 sends a request message 512 to the user context database 280 to store the updated user context as a new version, e.g., {K, Val′, Ver N+1}.

The user context database 280 receives the request message 512 and checks the version of the user context that is being stored against the version currently stored in the database. If the user context database 280 determines that the version is not acceptable (because, for example, another instance of the service had already updated the user context), the user context database 280 returns an error message 516 to the service 210 indicating that the store request was unsuccessful. The service 210 then returns an error message 518 to the sender service ID, which can re-try the transaction later as described above. The error message 518 may include the original transaction ID.

If the version that the request message 512 specifies is acceptable, e.g., the version in the request is one version greater than the most recently stored version, then the user context database 280 returns a message 520 to the service 210 indicating that the new user context was successfully stored (“Ok”). The service 210 then sends a secondary request 522 to another service 220 (“Service Y”) including the service ID of the service 210, the user ID, and the transaction ID.

FIG. 6 is a flowchart of operations of a service upon receiving a response to a request previously sent by the service. As shown therein, a recipient service (e.g., Service X) may receive a response message from another service (e.g., Service Y) that includes a user ID and a transaction ID (block 602). The recipient service (Service X) reads the user context associated with the user ID identified in the response from the user context database (block 604). The recipient service first checks to make sure that the transaction ID contained in the user context matches the transaction ID included in the response message (block 606). If the transaction IDs do not match, the recipient service may simply drop the response message (block 618) and end the procedure.

The recipient service then checks at block 608 to see if the response message indicates a transaction clash. If so, the recipient service may restore the user context to a version before the transaction started based on the transaction ID via an appropriate command to the user context database, and end the procedure.

If the response does not indicate a transaction clash, the recipient service next checks the “Messages Sent” table in the user context to determine if there is an outstanding request message to Service Y. If not, the recipient service may simply drop the response message at block 618 and end the procedure. Otherwise, if the “Messages Sent” table indicates that a response from Service Y was outstanding, the recipient service marks the reply as “received” in the “Messages Sent” table of the local user context (block 614).

The recipient service then determines based on the “Messages Sent” table if any additional responses are expected (i.e., there are messages sent for which no reply has been received). If additional responses are not expected, operations proceed to location “B” in the flowchart of FIG. 3A where the recipient service processes the original request based on the response. Otherwise, if additional responses are expected, the recipient stores the local user context as an updated version in the user context database (block 620), and operations conclude.

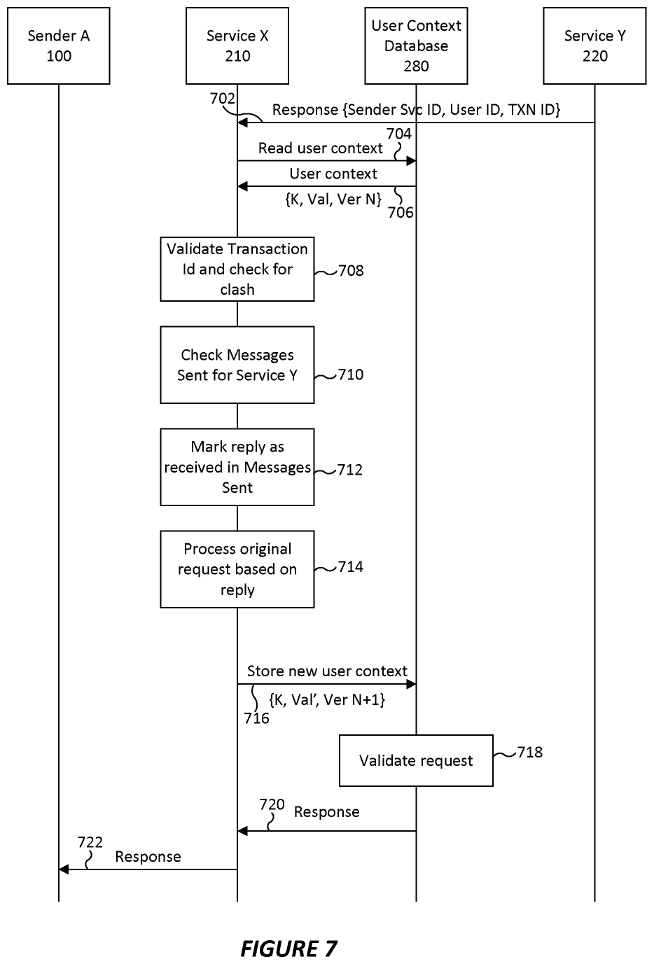

FIG. 7 is a flow diagram that illustrates an example of message flows between a sender 100, a service 210, a secondary service 220 and a user context database 280 when the secondary service 220 sends a response message to the service 210. Referring to FIG. 7, a secondary service 220 returns a response 702 to the service 210. The response 702 includes a sender service ID of the secondary service 220, a user ID and a transaction ID.

The service 210 reads the user context associated with the user ID identified in the response from the user context database via a message 704 to the user context database 280, which responds with a message 706 including the user context tuple {K, Val, Ver N}, which the service 210 stores in the local user context.

The service 210 then validates the transaction ID in the response 702 and checks for a transaction clash at block 708 by checking to make sure that the transaction ID contained in the user context matches the transaction ID included in the response message and that the response does not indicate a clash. Assuming in this example that the transaction IDs do match and that there is no transaction clash, the service 210 next checks the “Messages Sent” table in the user context to determine if there is an outstanding request message to Service Y (block 710). Assuming in this example that the “Messages Sent” table indicates that a response from Service Y was outstanding, the service 210 marks the reply as “received” in the “Messages Sent” table of the local user context (block 712). Assuming in this example that no additional responses are expected, the service 210 processes the original request based on the response (block 714) and attempts to store the updated user context in the user context database via a store request 716 to the user context database 280 specifying the updated user context as the tuple {K, Val′, Ver N+1}. The user context database 280 validates the store request at block 718 and sends an appropriate response 720 to the service 210, which in turn sends an appropriate response 722 to the sender 100.

Explanations for abbreviations from the above disclosure are provided below.

| Abbreviation | Explanation |
|---|---|
| AF | Application Function |
| AMF | Access and Mobility Management Function |
| AN | Access Network |
| AUSF | Authentication Server Function |
| DN | Data Network |
| EPC | Evolved Packet Core |
| MME | Mobility Management Entity |
| NSSF | Network Slice Selection Function |
| NRF | Network Repository Function |
| NEF | Network Exposure Function |
| PCF | Policy Control Function |
| PCRF | Policy and Charging Rules Function |
| RAN | Radio Access Network |
| SMF | Session Management Function |
| UDM | Unified Data Management |
| UE | User Equipment |
| UP | User Plane |
| UPF | User Plane Function |

Citations for references from the above disclosure are provided below.
Reference [1]: 3GPP TS 23.401
Reference [2]: 3GPP TS 23.501

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

Additional explanation is provided below.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Figure QQ1: A wireless network in accordance with some embodiments.

Although the subject matter described herein may be implemented in any appropriate type of system using any suitable components, the embodiments disclosed herein are described in relation to a wireless network, such as the example wireless network illustrated in Figure QQ1. For simplicity, the wireless network of Figure QQ1 only depicts network QQ106, network nodes QQ160 and QQ160b, and WDs QQ110, QQ110b, and QQ110c (also referred to as mobile terminals). In practice, a wireless network may further include any additional elements suitable to support communication between wireless devices or between a wireless device and another communication device, such as a landline telephone, a service provider, or any other network node or end device. Of the illustrated components, network node QQ160 and wireless device (WD) QQ110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network QQ106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node QQ160 and WD QQ110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In Figure QQ1, network node QQ160 includes processing circuitry QQ170, device readable medium QQ180, interface QQ190, auxiliary equipment QQ184, power source QQ186, power circuitry QQ187, and antenna QQ162. Although network node QQ160 illustrated in the example wireless network of Figure QQ1 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node QQ160 are depicted as single boxes located within a larger box, or nested within multiple boxes, in practice, a network node may comprise multiple different physical components that make up a single illustrated component (e.g., device readable medium QQ180 may comprise multiple separate hard drives as well as multiple RAM modules).

Similarly, network node QQ160 may be composed of multiple physically separate components (e.g., a NodeB component and a RNC component, or a BTS component and a BSC component, etc.), which may each have their own respective components. In certain scenarios in which network node QQ160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node QQ160 may be configured to support multiple radio access technologies (RATs). In such embodiments, some components may be duplicated (e.g., separate device readable medium QQ180 for the different RATs) and some components may be reused (e.g., the same antenna QQ162 may be shared by the RATs). Network node QQ160 may also include multiple sets of the various illustrated components for different wireless technologies integrated into network node QQ160, such as, for example, GSM, WCDMA, LTE, NR, WiFi, or Bluetooth wireless technologies. These wireless technologies may be integrated into the same or different chip or set of chips and other components within network node QQ160.

Processing circuitry QQ170 is configured to perform any determining, calculating, or similar operations (e.g., certain obtaining operations) described herein as being provided by a network node. These operations performed by processing circuitry QQ170 may include processing information obtained by processing circuitry QQ170 by, for example, converting the obtained information into other information, comparing the obtained information or converted information to information stored in the network node, and/or performing one or more operations based on the obtained information or converted information, and as a result of said processing making a determination.

Processing circuitry QQ170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ160 components, such as device readable medium QQ180, network node QQ160 functionality. For example, processing circuitry QQ170 may execute instructions stored in device readable medium QQ180 or in memory within processing circuitry QQ170. Such functionality may include providing any of the various wireless features, functions, or benefits discussed herein. In some embodiments, processing circuitry QQ170 may include a system on a chip (SOC).

In some embodiments, processing circuitry QQ170 may include one or more of radio frequency (RF) transceiver circuitry QQ172 and baseband processing circuitry QQ174. In some embodiments, radio frequency (RF) transceiver circuitry QQ172 and baseband processing circuitry QQ174 may be on separate chips (or sets of chips), boards, or units, such as radio units and digital units. In alternative embodiments, part or all of RF transceiver circuitry QQ172 and baseband processing circuitry QQ174 may be on the same chip or set of chips, boards, or units.

In certain embodiments, some or all of the functionality described herein as being provided by a network node, base station, eNB or other such network device may be performed by processing circuitry QQ170 executing instructions stored on device readable medium QQ180 or memory within processing circuitry QQ170. In alternative embodiments, some or all of the functionality may be provided by processing circuitry QQ170 without executing instructions stored on a separate or discrete device readable medium, such as in a hard-wired manner. In any of those embodiments, whether executing instructions stored on a device readable storage medium or not, processing circuitry QQ170 can be configured to perform the described functionality. The benefits provided by such functionality are not limited to processing circuitry QQ170 alone or to other components of network node QQ160, but are enjoyed by network node QQ160 as a whole, and/or by end users and the wireless network generally.

Device readable medium QQ180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry QQ170. Device readable medium QQ180 may store any suitable instructions, data or information, including a computer program, software, an application including one or more of logic, rules, code, tables, etc. and/or other instructions capable of being executed by processing circuitry QQ170 and, utilized by network node QQ160. Device readable medium QQ180 may be used to store any calculations made by processing circuitry QQ170 and/or any data received via interface QQ190. In some embodiments, processing circuitry QQ170 and device readable medium QQ180 may be considered to be integrated.

Interface QQ190 is used in the wired or wireless communication of signalling and/or data between network node QQ160, network QQ106, and/or WDs QQ110. As illustrated, interface QQ190 comprises port(s)/terminal(s) QQ194 to send and receive data, for example to and from network QQ106 over a wired connection. Interface QQ190 also includes radio front end circuitry QQ192 that may be coupled to, or in certain embodiments a part of, antenna QQ162. Radio front end circuitry QQ192 comprises filters QQ198 and amplifiers QQ196. Radio front end circuitry QQ192 may be connected to antenna QQ162 and processing circuitry QQ170. Radio front end circuitry may be configured to condition signals communicated between antenna QQ162 and processing circuitry QQ170. Radio front end circuitry QQ192 may receive digital data that is to be sent out to other network nodes or WDs via a wireless connection. Radio front end circuitry QQ192 may convert the digital data into a radio signal having the appropriate channel and bandwidth parameters using a combination of filters QQ198 and/or amplifiers QQ196. The radio signal may then be transmitted via antenna QQ162. Similarly, when receiving data, antenna QQ162 may collect radio signals which are then converted into digital data by radio front end circuitry QQ192. The digital data may be passed to processing circuitry QQ170. In other embodiments, the interface may comprise different components and/or different combinations of components.

In certain alternative embodiments, network node QQ160 may not include separate radio front end circuitry QQ192, instead, processing circuitry QQ170 may comprise radio front end circuitry and may be connected to antenna QQ162 without separate radio front end circuitry QQ192. Similarly, in some embodiments, all or some of RF transceiver circuitry QQ172 may be considered a part of interface QQ190. In still other embodiments, interface QQ190 may include one or more ports or terminals QQ194, radio front end circuitry QQ192, and RF transceiver circuitry QQ172, as part of a radio unit (not shown), and interface QQ190 may communicate with baseband processing circuitry QQ174, which is part of a digital unit (not shown).

Antenna QQ162 may include one or more antennas, or antenna arrays, configured to send and/or receive wireless signals. Antenna QQ162 may be coupled to radio front end circuitry QQ190 and may be any type of antenna capable of transmitting and receiving data and/or signals wirelessly. In some embodiments, antenna QQ162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna QQ162 may be separate from network node QQ160 and may be connectable to network node QQ160 through an interface or port.

Antenna QQ162, interface QQ190, and/or processing circuitry QQ170 may be configured to perform any receiving operations and/or certain obtaining operations described herein as being performed by a network node. Any information, data and/or signals may be received from a wireless device, another network node and/or any other network equipment. Similarly, antenna QQ162, interface QQ190, and/or processing circuitry QQ170 may be configured to perform any transmitting operations described herein as being performed by a network node. Any information, data and/or signals may be transmitted to a wireless device, another network node and/or any other network equipment.

Power circuitry QQ187 may comprise, or be coupled to, power management circuitry and is configured to supply the components of network node QQ160 with power for performing the functionality described herein. Power circuitry QQ187 may receive power from power source QQ186. Power source QQ186 and/or power circuitry QQ187 may be configured to provide power to the various components of network node QQ160 in a form suitable for the respective components (e.g., at a voltage and current level needed for each respective component). Power source QQ186 may either be included in, or external to, power circuitry QQ187 and/or network node QQ160. For example, network node QQ160 may be connectable to an external power source (e.g., an electricity outlet) via an input circuitry or interface such as an electrical cable, whereby the external power source supplies power to power circuitry QQ187. As a further example, power source QQ186 may comprise a source of power in the form of a battery or battery pack which is connected to, or integrated in, power circuitry QQ187. The battery may provide backup power should the external power source fail. Other types of power sources, such as photovoltaic devices, may also be used.

Alternative embodiments of network node QQ160 may include additional components beyond those shown in Figure QQ1 that may be responsible for providing certain aspects of the network node's functionality, including any of the functionality described herein and/or any functionality necessary to support the subject matter described herein. For example, network node QQ160 may include user interface equipment to allow input of information into network node QQ160 and to allow output of information from network node QQ160. This may allow a user to perform diagnostic, maintenance, repair, and other administrative functions for network node QQ160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device QQ110 includes antenna QQ111, interface QQ114, processing circuitry QQ120, device readable medium QQ130, user interface equipment QQ132, auxiliary equipment QQ134, power source QQ136 and power circuitry QQ137. WD QQ110 may include multiple sets of one or more of the illustrated components for different wireless technologies supported by WD QQ110, such as, for example, GSM, WCDMA, LTE, NR, WiFi, WiMAX, or Bluetooth wireless technologies, just to mention a few. These wireless technologies may be integrated into the same or different chips or set of chips as other components within WD QQ110.

Antenna QQ111 may include one or more antennas or antenna arrays, configured to send and/or receive wireless signals, and is connected to interface QQ114. In certain alternative embodiments, antenna QQ111 may be separate from WD QQ110 and be connectable to WD QQ110 through an interface or port. Antenna QQ111, interface QQ114, and/or processing circuitry QQ120 may be configured to perform any receiving or transmitting operations described herein as being performed by a WD. Any information, data and/or signals may be received from a network node and/or another WD. In some embodiments, radio front end circuitry and/or antenna QQ111 may be considered an interface.

As illustrated, interface QQ114 comprises radio front end circuitry QQ112 and antenna QQ111. Radio front end circuitry QQ112 comprise one or more filters QQ118 and amplifiers QQ116. Radio front end circuitry QQ114 is connected to antenna QQ111 and processing circuitry QQ120, and is configured to condition signals communicated between antenna QQ111 and processing circuitry QQ120. Radio front end circuitry QQ112 may be coupled to or a part of antenna QQ111. In some embodiments, WD QQ110 may not include separate radio front end circuitry QQ112; rather, processing circuitry QQ120 may comprise radio front end circuitry and may be connected to antenna QQ111. Similarly, in some embodiments, some or all of RF transceiver circuitry QQ122 may be considered a part of interface QQ114. Radio front end circuitry QQ112 may receive digital data that is to be sent out to other network nodes or WDs via a wireless connection. Radio front end circuitry QQ112 may convert the digital data into a radio signal having the appropriate channel and bandwidth parameters using a combination of filters QQ118 and/or amplifiers QQ116. The radio signal may then be transmitted via antenna QQ111. Similarly, when receiving data, antenna QQ111 may collect radio signals which are then converted into digital data by radio front end circuitry QQ112. The digital data may be passed to processing circuitry QQ120. In other embodiments, the interface may comprise different components and/or different combinations of components.

Processing circuitry QQ120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD QQ110 components, such as device readable medium QQ130, WD QQ110 functionality. Such functionality may include providing any of the various wireless features or benefits discussed herein. For example, processing circuitry QQ120 may execute instructions stored in device readable medium QQ130 or in memory within processing circuitry QQ120 to provide the functionality disclosed herein.

As illustrated, processing circuitry QQ120 includes one or more of RF transceiver circuitry QQ122, baseband processing circuitry QQ124, and application processing circuitry QQ126. In other embodiments, the processing circuitry may comprise different components and/or different combinations of components. In certain embodiments processing circuitry QQ120 of WD QQ110 may comprise a SOC. In some embodiments, RF transceiver circuitry QQ122, baseband processing circuitry QQ124, and application processing circuitry QQ126 may be on separate chips or sets of chips. In alternative embodiments, part or all of baseband processing circuitry QQ124 and application processing circuitry QQ126 may be combined into one chip or set of chips, and RF transceiver circuitry QQ122 may be on a separate chip or set of chips. In still alternative embodiments, part or all of RF transceiver circuitry QQ122 and baseband processing circuitry QQ124 may be on the same chip or set of chips, and application processing circuitry QQ126 may be on a separate chip or set of chips. In yet other alternative embodiments, part or all of RF transceiver circuitry QQ122, baseband processing circuitry QQ124, and application processing circuitry QQ126 may be combined in the same chip or set of chips. In some embodiments, RF transceiver circuitry QQ122 may be a part of interface QQ114. RF transceiver circuitry QQ122 may condition RF signals for processing circuitry QQ120.

In certain embodiments, some or all of the functionality described herein as being performed by a WD may be provided by processing circuitry QQ120 executing instructions stored on device readable medium QQ130, which in certain embodiments may be a computer-readable storage medium. In alternative embodiments, some or all of the functionality may be provided by processing circuitry QQ120 without executing instructions stored on a separate or discrete device readable storage medium, such as in a hard-wired manner. In any of those particular embodiments, whether executing instructions stored on a device readable storage medium or not, processing circuitry QQ120 can be configured to perform the described functionality. The benefits provided by such functionality are not limited to processing circuitry QQ120 alone or to other components of WD QQ110, but are enjoyed by WD QQ110 as a whole, and/or by end users and the wireless network generally.

Processing circuitry QQ120 may be configured to perform any determining, calculating, or similar operations (e.g., certain obtaining operations) described herein as being performed by a WD. These operations, as performed by processing circuitry QQ120, may include processing information obtained by processing circuitry QQ120 by, for example, converting the obtained information into other information, comparing the obtained information or converted information to information stored by WD QQ110, and/or performing one or more operations based on the obtained information or converted information, and as a result of said processing making a determination.

Device readable medium QQ130 may be operable to store a computer program, software, an application including one or more of logic, rules, code, tables, etc. and/or other instructions capable of being executed by processing circuitry QQ120. Device readable medium QQ130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry QQ120. In some embodiments, processing circuitry QQ120 and device readable medium QQ130 may be considered to be integrated. User interface equipment QQ132 may provide components that allow for a human user to interact with WD QQ110. Such interaction may be of many forms, such as visual, audial, tactile, etc. User interface equipment QQ132 may be operable to produce output to the user and to allow the user to provide input to WD QQ110. The type of interaction may vary depending on the type of user interface equipment QQ132 installed in WD QQ110. For example, if WD QQ110 is a smart phone, the interaction may be via a touch screen; if WD QQ110 is a smart meter, the interaction may be through a screen that provides usage (e.g., the number of gallons used) or a speaker that provides an audible alert (e.g., if smoke is detected). User interface equipment QQ132 may include input interfaces, devices and circuits, and output interfaces, devices and circuits. User interface equipment QQ132 is configured to allow input of information into WD QQ110, and is connected to processing circuitry QQ120 to allow processing circuitry QQ120 to process the input information. User interface equipment QQ132 may include, for example, a microphone, a proximity or other sensor, keys/buttons, a touch display, one or more cameras, a USB port, or other input circuitry. User interface equipment QQ132 is also configured to allow output of information from WD QQ110, and to allow processing circuitry QQ120 to output information from WD QQ110. User interface equipment QQ132 may include, for example, a speaker, a display, vibrating circuitry, a USB port, a headphone interface, or other output circuitry. Using one or more input and output interfaces, devices, and circuits, of user interface equipment QQ132, WD QQ110 may communicate with end users and/or the wireless network, and allow them to benefit from the functionality described herein.

Auxiliary equipment QQ134 is operable to provide more specific functionality which may not be generally performed by WDs. This may comprise specialized sensors for doing measurements for various purposes, interfaces for additional types of communication such as wired communications etc. The inclusion and type of components of auxiliary equipment QQ134 may vary depending on the embodiment and/or scenario.

Power source QQ136 may, in some embodiments, be in the form of a battery or battery pack. Other types of power sources, such as an external power source (e.g., an electricity outlet), photovoltaic devices or power cells, may also be used. WD QQ110 may further comprise power circuitry QQ137 for delivering power from power source QQ136 to the various parts of WD QQ110 which need power from power source QQ136 to carry out any functionality described or indicated herein. Power circuitry QQ137 may in certain embodiments comprise power management circuitry. Power circuitry QQ137 may additionally or alternatively be operable to receive power from an external power source; in which case WD QQ110 may be connectable to the external power source (such as an electricity outlet) via input circuitry or an interface such as an electrical power cable. Power circuitry QQ137 may also in certain embodiments be operable to deliver power from an external power source to power source QQ136. This may be, for example, for the charging of power source QQ136. Power circuitry QQ137 may perform any formatting, converting, or other modification to the power from power source QQ136 to make the power suitable for the respective components of WD QQ110 to which power is supplied.

Figure QQ2: User Equipment in accordance with some embodiments

Figure QQ2 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE QQ2200 may be any UE identified by the 3rd Generation Partnership Project (3GPP), including a NB-IoT UE, a machine type communication (MTC) UE, and/or an enhanced MTC (eMTC) UE. UE QQ200, as illustrated in Figure QQ2, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although Figure QQ2 is a UE, the components discussed herein are equally applicable to a WD, and vice-versa.

In Figure QQ2, UE QQ200 includes processing circuitry QQ201 that is operatively coupled to input/output interface QQ205, radio frequency (RF) interface QQ209, network connection interface QQ211, memory QQ215 including random access memory (RAM) QQ217, read-only memory (ROM) QQ219, and storage medium QQ221 or the like, communication subsystem QQ231, power source QQ233, and/or any other component, or any combination thereof. Storage medium QQ221 includes operating system QQ223, application program QQ225, and data QQ227. In other embodiments, storage medium QQ221 may include other similar types of information. Certain UEs may utilize all of the components shown in Figure QQ2, or only a subset of the components. The level of integration between the components may vary from one UE to another UE. Further, certain UEs may contain multiple instances of a component, such as multiple processors, memories, transceivers, transmitters, receivers, etc.

In Figure QQ2, processing circuitry QQ201 may be configured to process computer instructions and data. Processing circuitry QQ201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry QQ201 may include two central processing units (CPUs). Data may be information in a form suitable for use by a computer.

In the depicted embodiment, input/output interface QQ205 may be configured to provide a communication interface to an input device, output device, or input and output device. UE QQ200 may be configured to use an output device via input/output interface QQ205. An output device may use the same type of interface port as an input device. For example, a USB port may be used to provide input to and output from UE QQ200. The output device may be a speaker, a sound card, a video card, a display, a monitor, a printer, an actuator, an emitter, a smartcard, another output device, or any combination thereof. UE QQ200 may be configured to use an input device via input/output interface QQ205 to allow a user to capture information into UE QQ200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In Figure QQ2, RF interface QQ209 may be configured to provide a communication interface to RF components such as a transmitter, a receiver, and an antenna. Network connection interface QQ211 may be configured to provide a communication interface to network QQ243a. Network QQ243a may encompass wired and/or wireless networks such as a local-area network (LAN), a wide-area network (WAN), a computer network, a wireless network, a telecommunications network, another like network or any combination thereof. For example, network QQ243a may comprise a Wi-Fi network. Network connection interface QQ211 may be configured to include a receiver and a transmitter interface used to communicate with one or more other devices over a communication network according to one or more communication protocols, such as Ethernet, TCP/IP, SONET, ATM, or the like. Network connection interface QQ211 may implement receiver and transmitter functionality appropriate to the communication network links (e.g., optical, electrical, and the like). The transmitter and receiver functions may share circuit components, software or firmware, or alternatively may be implemented separately.

RAM QQ217 may be configured to interface via bus QQ202 to processing circuitry QQ201 to provide storage or caching of data or computer instructions during the execution of software programs such as the operating system, application programs, and device drivers. ROM QQ219 may be configured to provide computer instructions or data to processing circuitry QQ201. For example, ROM QQ219 may be configured to store invariant low-level system code or data for basic system functions such as basic input and output (I/O), startup, or reception of keystrokes from a keyboard that are stored in a non-volatile memory. Storage medium QQ221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium QQ221 may be configured to include operating system QQ223, application program QQ225 such as a web browser application, a widget or gadget engine or another application, and data file QQ227. Storage medium QQ221 may store, for use by UE QQ200, any of a variety of various operating systems or combinations of operating systems.

Storage medium QQ221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium QQ221 may allow UE QQ200 to access computer-executable instructions, application programs or the like, stored on transitory or non-transitory memory media, to off-load data, or to upload data. An article of manufacture, such as one utilizing a communication system may be tangibly embodied in storage medium QQ221, which may comprise a device readable medium.

In Figure QQ2, processing circuitry QQ201 may be configured to communicate with network QQ243b using communication subsystem QQ231. Network QQ243a and network QQ243b may be the same network or networks or different network or networks. Communication subsystem QQ231 may be configured to include one or more transceivers used to communicate with network QQ243b. For example, communication subsystem QQ231 may be configured to include one or more transceivers used to communicate with one or more remote transceivers of another device capable of wireless communication such as another WD, UE, or base station of a radio access network (RAN) according to one or more communication protocols, such as IEEE 802.QQ2, CDMA, WCDMA, GSM, LTE, UTRAN, WiMax, or the like. Each transceiver may include transmitter QQ233 and/or receiver QQ235 to implement transmitter or receiver functionality, respectively, appropriate to the RAN links (e.g., frequency allocations and the like). Further, transmitter QQ233 and receiver QQ235 of each transceiver may share circuit components, software or firmware, or alternatively may be implemented separately.

In the illustrated embodiment, the communication functions of communication subsystem QQ231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem QQ231 may include cellular communication, Wi-Fi communication, Bluetooth communication, and GPS communication. Network QQ243b may encompass wired and/or wireless networks such as a local-area network (LAN), a wide-area network (WAN), a computer network, a wireless network, a telecommunications network, another like network or any combination thereof. For example, network QQ243b may be a cellular network, a Wi-Fi network, and/or a near-field network. Power source QQ213 may be configured to provide alternating current (AC) or direct current (DC) power to components of UE QQ200.

The features, benefits and/or functions described herein may be implemented in one of the components of UE QQ200 or partitioned across multiple components of UE QQ200. Further, the features, benefits, and/or functions described herein may be implemented in any combination of hardware, software or firmware. In one example, communication subsystem QQ231 may be configured to include any of the components described herein. Further, processing circuitry QQ201 may be configured to communicate with any of such components over bus QQ202. In another example, any of such components may be represented by program instructions stored in memory that when executed by processing circuitry QQ201 perform the corresponding functions described herein. In another example, the functionality of any of such components may be partitioned between processing circuitry QQ201 and communication subsystem QQ231. In another example, the non-computationally intensive functions of any of such components may be implemented in software or firmware and the computationally intensive functions may be implemented in hardware.

FIG. QQ3: Virtualization environment in accordance with some embodiments

FIG. QQ3 is a schematic block diagram illustrating a virtualization environment QQ300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments QQ300 hosted by one or more of hardware nodes QQ330. Further, in embodiments in which the virtual node is not a radio access node or does not require radio connectivity (e.g., a core network node), then the network node may be entirely virtualized.

The functions may be implemented by one or more applications QQ320 (which may alternatively be called software instances, virtual appliances, network functions, virtual nodes, virtual network functions, etc.) operative to implement some of the features, functions, and/or benefits of some of the embodiments disclosed herein. Applications QQ320 are run in virtualization environment QQ300 which provides hardware QQ330 comprising processing circuitry QQ360 and memory QQ390. Memory QQ390 contains instructions QQ395 executable by processing circuitry QQ360 whereby application QQ320 is operative to provide one or more of the features, benefits, and/or functions disclosed herein.

Virtualization environment QQ300, comprises general-purpose or special-purpose network hardware devices QQ330 comprising a set of one or more processors or processing circuitry QQ360, which may be commercial off-the-shelf (COTS) processors, dedicated Application Specific Integrated Circuits (ASICs), or any other type of processing circuitry including digital or analog hardware components or special purpose processors. Each hardware device may comprise memory QQ390-1 which may be non-persistent memory for temporarily storing instructions QQ395 or software executed by processing circuitry QQ360. Each hardware device may comprise one or more network interface controllers (NICs) QQ370, also known as network interface cards, which include physical network interface QQ380. Each hardware device may also include non-transitory, persistent, machine-readable storage media QQ390-2 having stored therein software QQ395 and/or instructions executable by processing circuitry QQ360. Software QQ395 may include any type of software including software for instantiating one or more virtualization layers QQ350 (also referred to as hypervisors), software to execute virtual machines QQ340 as well as software allowing it to execute functions, features and/or benefits described in relation with some embodiments described herein.

Virtual machines QQ340, comprise virtual processing, virtual memory, virtual networking or interface and virtual storage, and may be run by a corresponding virtualization layer QQ350 or hypervisor. Different embodiments of the instance of virtual appliance QQ320 may be implemented on one or more of virtual machines QQ340, and the implementations may be made in different ways.

During operation, processing circuitry QQ360 executes software QQ395 to instantiate the hypervisor or virtualization layer QQ350, which may sometimes be referred to as a virtual machine monitor (VMM). Virtualization layer QQ350 may present a virtual operating platform that appears like networking hardware to virtual machine QQ340.

As shown in Figure QQ3, hardware QQ330 may be a standalone network node with generic or specific components. Hardware QQ330 may comprise antenna QQ3225 and may implement some functions via virtualization. Alternatively, hardware QQ330 may be part of a larger cluster of hardware (e.g. such as in a data center or customer premise equipment (CPE)) where many hardware nodes work together and are managed via management and orchestration (MANO) QQ3100, which, among others, oversees lifecycle management of applications QQ320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine QQ340 may be a software implementation of a physical machine that runs programs as if they were executing on a physical, non-virtualized machine. Each of virtual machines QQ340, and that part of hardware QQ330 that executes that virtual machine, be it hardware dedicated to that virtual machine and/or hardware shared by that virtual machine with others of the virtual machines QQ340, forms a separate virtual network elements (VNE).

Still in the context of NFV, Virtual Network Function (VNF) is responsible for handling specific network functions that run in one or more virtual machines QQ340 on top of hardware networking infrastructure QQ330 and corresponds to application QQ320 in Figure QQ3.

In some embodiments, one or more radio units QQ3200 that each include one or more transmitters QQ3220 and one or more receivers QQ3210 may be coupled to one or more antennas QQ3225. Radio units QQ3200 may communicate directly with hardware nodes QQ330 via one or more appropriate network interfaces and may be used in combination with the virtual components to provide a virtual node with radio capabilities, such as a radio access node or a base station.

In some embodiments, some signalling can be effected with the use of control system QQ3230 which may alternatively be used for communication between the hardware nodes QQ330 and radio units QQ3200.

Figure QQ4: Telecommunication network connected via an intermediate network to a host computer in accordance with some embodiments.

With reference to FIGURE QQ4, in accordance with an embodiment, a communication system includes telecommunication network QQ410, such as a 3GPP-type cellular network, which comprises access network QQ411, such as a radio access network, and core network QQ414. Access network QQ411 comprises a plurality of base stations QQ412a, QQ412b, QQ412c, such as NBs, eNBs, gNBs or other types of wireless access points, each defining a corresponding coverage area QQ413a, QQ413b, QQ413c. Each base station QQ412a, QQ412b, QQ412c is connectable to core network QQ414 over a wired or wireless connection QQ415. A first UE QQ491 located in coverage area QQ413c is configured to wirelessly connect to, or be paged by, the corresponding base station QQ412c. A second UE QQ492 in coverage area QQ413a is wirelessly connectable to the corresponding base station QQ412a. While a plurality of UEs QQ491, QQ492 are illustrated in this example, the disclosed embodiments are equally applicable to a situation where a sole UE is in the coverage area or where a sole UE is connecting to the corresponding base station QQ412.

Telecommunication network QQ410 is itself connected to host computer QQ430, which may be embodied in the hardware and/or software of a standalone server, a cloud-implemented server, a distributed server or as processing resources in a server farm. Host computer QQ430 may be under the ownership or control of a service provider, or may be operated by the service provider or on behalf of the service provider. Connections QQ421 and QQ422 between telecommunication network QQ410 and host computer QQ430 may extend directly from core network QQ414 to host computer QQ430 or may go via an optional intermediate network QQ420. Intermediate network QQ420 may be one of, or a combination of more than one of, a public, private or hosted network; intermediate network QQ420, if any, may be a backbone network or the Internet; in particular, intermediate network QQ420 may comprise two or more sub-networks (not shown).

The communication system of Figure QQ4 as a whole enables connectivity between the connected UEs QQ491, QQ492 and host computer QQ430. The connectivity may be described as an over-the-top (OTT) connection QQ450. Host computer QQ430 and the connected UEs QQ491, 00492 are configured to communicate data and/or signaling via OTT connection QQ450, using access network QQ411, core network QQ414, any intermediate network QQ420 and possible further infrastructure (not shown) as intermediaries. OTT connection QQ450 may be transparent in the sense that the participating communication devices through which OTT connection QQ450 passes are unaware of routing of uplink and downlink communications. For example, base station QQ412 may not or need not be informed about the past routing of an incoming downlink communication with data originating from host computer QQ430 to be forwarded (e.g., handed over) to a connected UE QQ491. Similarly, base station QQ412 need not be aware of the future routing of an outgoing uplink communication originating from the UE QQ491 towards the host computer QQ430.

Figure QQ5: Host computer communicating via a base station with a user equipment over a partially wireless connection in accordance with some embodiments.

Example implementations, in accordance with an embodiment, of the UE, base station and host computer discussed in the preceding paragraphs will now be described with reference to Figure QQ5. In communication system QQ500, host computer QQ510 comprises hardware QQ515 including communication interface QQ516 configured to set up and maintain a wired or wireless connection with an interface of a different communication device of communication system QQ500. Host computer QQ510 further comprises processing circuitry QQ518, which may have storage and/or processing capabilities. In particular, processing circuitry QQ518 may comprise one or more programmable processors, application-specific integrated circuits, field programmable gate arrays or combinations of these (not shown) adapted to execute instructions. Host computer QQ510 further comprises software QQ511, which is stored in or accessible by host computer QQ510 and executable by processing circuitry QQ518. Software QQ511 includes host application QQ512. Host application QQ512 may be operable to provide a service to a remote user, such as UE QQ530 connecting via OTT connection QQ550 terminating at UE QQ530 and host computer QQ510. In providing the service to the remote user, host application QQ512 may provide user data which is transmitted using OTT connection QQ550.

Communication system QQ500 further includes base station QQ520 provided in a telecommunication system and comprising hardware QQ525 enabling it to communicate with host computer QQ510 and with UE QQ530. Hardware QQ525 may include communication interface QQ526 for setting up and maintaining a wired or wireless connection with an interface of a different communication device of communication system QQ500, as well as radio interface QQ527 for setting up and maintaining at least wireless connection QQ570 with UE QQ530 located in a coverage area (not shown in Figure QQ5) served by base station QQ520. Communication interface QQ526 may be configured to facilitate connection QQ560 to host computer QQ510. Connection QQ560 may be direct or it may pass through a core network (not shown in Figure QQ5) of the telecommunication system and/or through one or more intermediate networks outside the telecommunication system. In the embodiment shown, hardware QQ525 of base station QQ520 further includes processing circuitry QQ528, which may comprise one or more programmable processors, application-specific integrated circuits, field programmable gate arrays or combinations of these (not shown) adapted to execute instructions. Base station QQ520 further has software QQ521 stored internally or accessible via an external connection.

Communication system QQ500 further includes UE QQ530 already referred to. Its hardware QQ535 may include radio interface QQ537 configured to set up and maintain wireless connection QQ570 with a base station serving a coverage area in which UE QQ530 is currently located. Hardware QQ535 of UE QQ530 further includes processing circuitry QQ538, which may comprise one or more programmable processors, application-specific integrated circuits, field programmable gate arrays or combinations of these (not shown) adapted to execute instructions. UE QQ530 further comprises software QQ531, which is stored in or accessible by UE QQ530 and executable by processing circuitry QQ538. Software QQ531 includes client application QQ532. Client application QQ532 may be operable to provide a service to a human or non-human user via UE QQ530, with the support of host computer QQ510. In host computer QQ510, an executing host application QQ512 may communicate with the executing client application QQ532 via OTT connection QQ550 terminating at UE QQ530 and host computer QQ510. In providing the service to the user, client application QQ532 may receive request data from host application QQ512 and provide user data in response to the request data. OTT connection QQ550 may transfer both the request data and the user data. Client application QQ532 may interact with the user to generate the user data that it provides.

It is noted that host computer QQ510, base station QQ520 and UE QQ530 illustrated in Figure QQ5 may be similar or identical to host computer QQ430, one of base stations QQ412a, QQ412b, QQ412c and one of UEs QQ491, QQ492 of Figure QQ4, respectively. This is to say, the inner workings of these entities may be as shown in Figure QQ5 and independently, the surrounding network topology may be that of Figure QQ4.

In Figure QQ5, OTT connection QQ550 has been drawn abstractly to illustrate the communication between host computer QQ510 and UE QQ530 via base station QQ520, without explicit reference to any intermediary devices and the precise routing of messages via these devices. Network infrastructure may determine the routing, which it may be configured to hide from UE QQ530 or from the service provider operating host computer QQ510, or both. While OTT connection QQ550 is active, the network infrastructure may further take decisions by which it dynamically changes the routing (e.g., on the basis of load balancing consideration or reconfiguration of the network).

Wireless connection QQ570 between UE QQ530 and base station QQ520 is in accordance with the teachings of the embodiments described throughout this disclosure. One or more of the various embodiments may improve the performance of OTT services provided to UE QQ530 using OTT connection QQ550, in which wireless connection QQ570 forms the last segment. More precisely, the teachings of these embodiments may improve the deblock filtering for video processing and thereby provide benefits such as improved video encoding and/or decoding.

A measurement procedure may be provided for the purpose of monitoring data rate, latency and other factors on which the one or more embodiments improve. There may further be an optional network functionality for reconfiguring OTT connection QQ550 between host computer QQ510 and UE QQ530, in response to variations in the measurement results. The measurement procedure and/or the network functionality for reconfiguring OTT connection QQ550 may be implemented in software QQ511 and hardware QQ515 of host computer QQ510 or in software QQ531 and hardware QQ535 of UE QQ530, or both. In embodiments, sensors (not shown) may be deployed in or in association with communication devices through which OTT connection QQ550 passes; the sensors may participate in the measurement procedure by supplying values of the monitored quantities exemplified above, or supplying values of other physical quantities from which software QQ511, QQ531 may compute or estimate the monitored quantities. The reconfiguring of OTT connection QQ550 may include message format, retransmission settings, preferred routing etc.; the reconfiguring need not affect base station QQ520, and it may be unknown or imperceptible to base station QQ520. Such procedures and functionalities may be known and practiced in the art. In certain embodiments, measurements may involve proprietary UE signaling facilitating host computer QQ510's measurements of throughput, propagation times, latency and the like. The measurements may be implemented in that software QQ511 and QQ531 causes messages to be transmitted, in particular empty or ‘dummy’ messages, using OTT connection QQ550 while it monitors propagation times, errors etc.

Figure QQ6: Methods implemented in a communication system including a host computer, a base station and a user equipment in accordance with some embodiments.

Figure QQ6 is a flowchart illustrating a method implemented in a communication system, in accordance with one embodiment. The communication system includes a host computer, a base station and a UE which may be those described with reference to FIGS. QQ4 and QQ5. For simplicity of the present disclosure, only drawing references to Figure QQ6 will be included in this section. In step QQ610, the host computer provides user data. In substep QQ611 (which may be optional) of step QQ610, the host computer provides the user data by executing a host application. In step QQ620, the host computer initiates a transmission carrying the user data to the UE. In step QQ630 (which may be optional), the base station transmits to the UE the user data which was carried in the transmission that the host computer initiated, in accordance with the teachings of the embodiments described throughout this disclosure. In step QQ640 (which may also be optional), the UE executes a client application associated with the host application executed by the host computer.

FIG. 007: Methods implemented in a communication system including a host computer, a base station and a user equipment in accordance with some embodiments.

FIG. 007 is a flowchart illustrating a method implemented in a communication system, in accordance with one embodiment. The communication system includes a host computer, a base station and a UE which may be those described with reference to FIGS. QQ4 and QQ5. For simplicity of the present disclosure, only drawing references to FIG. 007 will be included in this section. In step QQ710 of the method, the host computer provides user data. In an optional substep (not shown) the host computer provides the user data by executing a host application. In step QQ720, the host computer initiates a transmission carrying the user data to the UE. The transmission may pass via the base station, in accordance with the teachings of the embodiments described throughout this disclosure. In step QQ730 (which may be optional), the UE receives the user data carried in the transmission.

FIG. 008: Methods implemented in a communication system including a host computer, a base station and a user equipment in accordance with some embodiments.

FIG. 008 is a flowchart illustrating a method implemented in a communication system, in accordance with one embodiment. The communication system includes a host computer, a base station and a UE which may be those described with reference to FIGS. QQ4 and QQ5. For simplicity of the present disclosure, only drawing references to FIG. 008 will be included in this section. In step QQ810 (which may be optional), the UE receives input data provided by the host computer. Additionally or alternatively, in step QQ820, the UE provides user data. In substep QQ821 (which may be optional) of step QQ820, the UE provides the user data by executing a client application. In substep QQ811 (which may be optional) of step QQ810, the UE executes a client application which provides the user data in reaction to the received input data provided by the host computer. In providing the user data, the executed client application may further consider user input received from the user. Regardless of the specific manner in which the user data was provided, the UE initiates, in substep QQ830 (which may be optional), transmission of the user data to the host computer. In step QQ840 of the method, the host computer receives the user data transmitted from the UE, in accordance with the teachings of the embodiments described throughout this disclosure.

Figure QQ9: Methods implemented in a communication system including a host computer, a base station and a user equipment in accordance with some embodiments.

Figure QQ9 is a flowchart illustrating a method implemented in a communication system, in accordance with one embodiment. The communication system includes a host computer, a base station and a UE which may be those described with reference to FIGS. QQ4 and QQ5. For simplicity of the present disclosure, only drawing references to Figure QQ9 will be included in this section. In step QQ910 (which may be optional), in accordance with the teachings of the embodiments described throughout this disclosure, the base station receives user data from the UE. In step QQ920 (which may be optional), the base station initiates transmission of the received user data to the host computer. In step QQ930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Embodiments of the present inventive concepts are described herein with reference to the accompanying drawings, in which embodiments of the inventive concepts are shown. The inventive concepts may, however, be embodied in many different forms and should not be construed as limited to the embodiments set forth herein. Rather, these embodiments are provided so that this disclosure will be thorough and complete, and will fully convey the scope of the inventive concepts to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present inventive concepts. As used herein, the term “and/or” includes any and all combinations of one or more of the associated listed items.

The terminology used herein is for the purpose of describing particular embodiments only and is not intended to be limiting of the inventive concepts. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the inventive concepts belongs. It will be further understood that terms used herein should be interpreted as having a meaning that is consistent with their meaning in the context of this specification and the relevant art.

As will be appreciated by one of skill in the art, the present inventive concepts may be embodied as a method, computing device, and/or computer program product. Accordingly, the present inventive concepts may take the form of an entirely hardware embodiment, an entirely software embodiment or an embodiment combining software and hardware aspects all generally referred to herein as a “circuit” or “module.” Furthermore, the present inventive concepts may take the form of a computer program product on a tangible computer usable storage medium having computer program code embodied in the medium that can be executed by a computer. Any suitable tangible computer readable medium may be utilized including hard disks, CD ROMs, optical storage devices, or magnetic storage devices.

The embodiments described herein provide useful physical machines and particularly configured computer hardware arrangements of computing devices, servers, processors, memory, networks, for example. Components of the computer may include, but are not limited to, a processing unit including a processor circuit, such as a programmable microprocessor or microcontroller, a system memory, and a system bus that couples various system components including the system memory to the processor circuit.

The processor circuit may be a multi-core processor including two or more independent processor circuits. Each of the cores in the processor circuit may support multi-threading operations, i.e., may have the capability to execute multiple processes or threads concurrently. Additionally, the processor circuit may have an on-board memory cache. In general, the processor circuit may, for example, include any type of general-purpose microprocessor or microcontroller, a digital signal processing (DSP) processor, an integrated circuit, a field programmable gate array (FPGA), a reconfigurable processor, a programmable read-only memory (PROM), or any combination thereof.

The system bus may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer typically includes a variety of computer readable media. Computer readable media can be any available media that can be accessed by computer and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic disk storage or other magnetic storage devices, or any other medium which can be used to store the desired information and which can accessed by the computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory includes computer storage media in the form of volatile and/or nonvolatile memory such as read only memory (ROM) and random access memory (RAM). A basic input/output system (BIOS), containing the basic routines that help to transfer information between elements within the computer, such as during start-up, is typically stored in the ROM. The RAM typically contains data and/or program modules that are immediately accessible to and/or presently being operated on by the processor circuit. The system memory may store an operating system, application programs, other program modules, and program data.

The computer may also include other removable/non-removable, volatile/nonvolatile computer storage media. By way of example only, the computer may include a hard disk drive reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk such as a CD ROM or other optical media. Other removable/non-removable, volatile/nonvolatile computer storage media that can be used in the illustrative operating environment include, but are not limited to, magnetic tape cassettes, flash memory cards, digital versatile disks, digital video tape, solid state RAM, solid state ROM, and the like. The hard disk drive is typically connected to the system bus through a non-removable memory interface.

The drives and their associated computer storage media discussed above provide storage of computer readable instructions, data structures, program modules and other data for the computer. A user may enter commands and information into the computer through input devices such as a keyboard and pointing device, commonly referred to as a mouse, trackball or touch pad. Other input devices (not shown) may include a microphone, joystick, game pad, satellite dish, scanner, touchscreen, or the like. These and other input devices are often connected to the processor circuit through a user input interface that is coupled to the system bus, but may be connected by other interface and bus structures, such as a parallel port, game port or a universal serial bus (USB). A monitor or other type of display device is also connected to the system bus via an interface, such as a video interface. In addition to the monitor, computers may also include other peripheral output devices such as speakers and a printer, which may be connected through an output peripheral interface.

The computer may operate in a networked environment using logical connections to one or more remote computers, such as a remote computer. The remote computer may be a personal computer, a server, a router, a network PC, a peer device or other common network node, and typically includes many or all of the elements described above relative to the computer. The logical connections include a local area network (LAN) connection and a wide area network (WAN) connection, but may also include other networks. Such networking environments are commonplace in offices, enterprise-wide computer networks, intranets and the Internet.

When used in a LAN networking environment, the computer may be connected to the LAN through a network interface or adapter. When used in a WAN networking environment, the computer may include a modem or other means for establishing communications over the WAN. The modem, which may be internal or external, may be connected to the system bus via the user input interface, or other appropriate mechanism.

Some embodiments of the present inventive concepts are described herein with reference to flowchart illustrations and/or block diagrams of methods, systems and computer program products according to embodiments of the inventive concepts. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program instructions may be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

In the drawings and specification, there have been disclosed typical embodiments of the inventive concepts and, although specific terms are employed, they are used in a generic and descriptive sense only and not for purposes of limitation, the scope of the inventive concepts being set forth in the following claims.

1. A method of processing service requests in a service-based network architecture comprising a plurality of service instances, the method comprising:
receiving, at a service, a service request from a sender, the service request including a user identification, ID, associated with the request and a transaction ID associated with the request;
obtaining a user context associated with the user ID from a user context database, the user context including a user context version and a transaction ongoing flag;
determining based on the transaction ongoing flag whether a transaction involving the user ID is currently ongoing;
in response to determining that a transaction involving the user ID is not currently ongoing, processing the service request to obtain an updated key value; and
transmitting a store request to the user context database to store the updated key value, and an updated user context version in the user context database.

2. The method of claim 1, further comprising:
in response to determining based on the transaction ongoing flag that a transaction involving the user ID is currently ongoing, sending an error response to the sender in response to the service request.

3. The method of claim 1, further comprising:
determining, based on the service request, whether a secondary request is needed to fulfill the service request;
in response to determining that a secondary request is needed to fulfill the service request, setting the transaction ongoing flag to the transaction ID;
determining a service name of a secondary service; and
transmitting a second request to the user context database to store the transaction ongoing flag and the service name of the secondary service in the user context.

4. The method of claim 3, further comprising:
receiving a response message from the user context database indicating that the second request was not successfully fulfilled; and
in response to the response message from the user context database indicating that the second request was not successfully fulfilled, sending an error message to the sender in response to the service request.

5. The method of claim 3, further comprising:
receiving a response message from the user context database indicating that the second request was successfully fulfilled; and
in response to the response message from the user context database indicating that the second request was successfully fulfilled, sending a secondary service request to the secondary service, the secondary service request including the transaction ID and the user ID.

6. The method of claim 5, further comprising:
receiving, from the secondary service, a response to the secondary service request, wherein the response to the secondary service request comprises the transaction ID and the user ID;
obtaining the user context associated with the user ID from the user context database;
determining whether the user context indicates that a request message was sent to the secondary service; and
in response to determining that the user context indicates that a request message was sent to the secondary service, marking the user context to indicate that a response to the secondary service request was received.

7. The method of claim 6, further comprising:
determining whether the user context indicates that an additional request message is outstanding; and
in response to determining that the user context indicates that no additional request message is outstanding, processing the user context based on the response to the secondary service request.

8. The method of claim 6, further comprising:
determining whether the transaction ID in the response message matches a stored transaction ID in the user context; and
in response to determining that the transaction ID in the response message does not match the stored transaction ID in the user context, dropping the response message.

9. The method of claim 6, further comprising:
determining whether the response message indicates that a transaction clash has occurred; and
in response to determining that the response message indicates that a transaction clash has occurred, restoring the user context to a prior state based on the transaction ID.

10. The method of claim 3, further comprising:
in response to determining that a secondary request is needed to fulfill the service request, storing the service name of the secondary service in the user context prior to transmitting the second request to the user context database.

11. The method of claim 1, further comprising:
determining, based on the service request, that a secondary request is not needed to fulfill the service request; and
in response to determining that a secondary request is not needed to fulfill the service request, clearing a transaction ongoing flag in the user context prior to storing the user context in the user context database.

12. The method of claim 1, further comprising:
determining whether a re-try flag is set in the service request.

13. The method of claim 12, further comprising:
in response to determining that the re-try flag is set in the service request, determining whether the transaction ongoing flag in the user context matches the transaction ID included in the service request; and
in response to determining that the transaction ongoing flag in the user context matches the transaction ID included in the service request, restoring the user context to a prior state based on the transaction ID included in the service request.

14. The method of claim 13, further comprising:
in response to determining that the re-try flag is set in the service request, determining whether a reply to the service request has already been sent to the sender; and
in response to determining that a reply to the service request has already been sent, re-sending the reply to the sender.

15. The method of claim 1, wherein the user context database comprises a versioned key-value store where the user ID is encoded in a key name and the user context is encoded in a value associated with the key name.

16. A network node of a communication network, the network node comprising:
a network interface configured to provide network communication with other network nodes; and
a processor coupled with the transceiver, wherein the processor is configured to provide wireless network communications through the transceiver, and wherein the processor is configured to perform operations according to claim 1.

17. A network node of a communication network, wherein the network node is adapted to perform according to claim 1.
